(19) United States
(12) Patent Application Publication
(10) Pub. No.: US 2025/0337271 A1
(43) Pub. Date: Oct. 30, 2025

(54) REAL TIME ESTIMATION OF TRANSMISSION LINE RATING PARAMETERS, TEMPERATURES, AND TRANSMISSION LINE HEALTH

(71) Applicant: Topolonet Corporation, San Diego, CA (US)

(72) Inventors: Ashkan Ashrafi, San Diego, CA (US); Rafael Zacharia Weinstein, San Diego, CA (US)

(21) Appl. No.: 19/192,156

(22) Filed: Apr. 28, 2025

Related U.S. Application Data
(60) Provisional application No. 63/639,135, filed on Apr. 26, 2024.

(51) Int. Cl. H02J 13/00

(52) U.S. Cl. CPC H02J 13/00002; H02J 13/00006

(57) ABSTRACT

A technique is disclosed to use time series phasor data to perform real-time dynamic line rating of electric power transmission lines. A variety of techniques are used to generate well-poised solutions to the determination of transmission line parameters from phasor data. Line health information can also be determined from changes to transmission line parameters, such as galloping, icing, vegetation encroachment, imperfect splicing, and conductor corrosion.

### CROSS REFERENCE TO RELATED APPLICATIONS

The present disclosure claims the benefit of provisional application 63/639,125, filed on Apr. 26, 2024.

### FIELD OF THE INVENTION

The present disclosure generally relates to remotely monitoring parameters of transmission power lines.

### BACKGROUND

As the demand for electricity grows, so does the problem of grid congestion, particularly in highly populated areas. Pacific Gas & Electric reports that the construction of new high voltage transmission lines costs approximately between $1.8M and $3.8M per mile. Therefore, finding ways to increase the current-carrying-capacity (CCC), or ampacity of existing transmission lines to overcome congestion is a priority for utility companies.

Real-time Dynamic Line Rating (DLR) presents a solution to grid congestion issues. A 2017 study by American Electric Power demonstrated the benefits of DLR in a simulation on the 22-mile Cook-Olive 345 kV transmission line. The study found that the installation and implementation of DLR would cost approximately $0.5 million, with potential annual net congestion savings exceeding $4 million. In December 2021, the Federal Energy Regulatory Commission (FERC) issued Order No. 881, mandating that public utility transmission providers adopt ambient-adjusted ratings for their transmission lines. The ambient-adjusted ratings reflect the impact of ambient temperature, solar heating, and other weather-related conditions on the transmission lines' capacity.

However, existing technologies only provide indirect estimates of the ampacity. These methods rely on temperature measurements taken directly from the lines, as well as environmental factors like wind speed, solar radiation, and heat dissipation from conductors. Observation of line sagging is conducted through video cameras or LiDAR. To derive the ampacity from these measurements, a complex mathematical model is required. This mathematical model is governed by IEEE-738 (regarding performing ampacity calculations based on current-temperature relationship of bare overhead lines) and CIGRE-207 (thermal behavior of overhead conductors) standards. The Institute of Electrical and Electronics Engineers (IEEE) is a well-known non-profit organization that has a standards association that promotes industry standards. The international council on larger electric systems (CIGRE) is another well-known international non-profit organization that promotes standards.

These conventional DLR approaches necessitate wireless data communication infrastructure, such as high-speed internet, for data transmission that is vulnerable to cyber-attacks and disruptions. The combined requirements of existing DLR technologies are a problem in terms of significant costs and logistical challenges for utility companies.

### SUMMARY

An apparatus, system, and method are disclosed for generating dynamic line ratings of an electric transmission line, based on phasor data measured from phasor measurement units. In one implementation, a system for monitoring and managing an electric power grid, includes a dynamic line rating engine configured to generate a line rating based on received time series phasor data of currents and voltages measured by synchro-phasor measurement units (PMUs) at two ends of an electric power transmission line, weather data, solar radiation data, and utility conductor parameters of the transmission line; the dynamic line rating engine generating preliminary estimates of temperatures of spans utilizing a heat balance equation that takes into account for a magnitude of the currents determined from the phasor data, the weather data, the solar radiation data, and the utility conductor parameters; and the dynamic line rating engine correcting the preliminary estimates of temperatures of spans, over a selected number of sample periods, by utilizing average line parameters calculated from the phasor data, as a source of information to determine coefficients of a non-linear correction equation. In one implementation, the average line parameters include average per unit line resistances. In one implementation, the dynamic line rating engine performs transmission line matrix calculations for the impedance \tilde{Z} and admittance \tilde{Y}, based on the phasor data, with the matrix calculations used to determine a line length and properties per unit length for a known transmission line geometry. In one implementation, the non-linear correction equation is a linear matrix of Taylor series expansions. In one implementation, the dynamic line rating engine determines a true temperature for each span and an ampacity for the spans taking into account the true temperature of each span.

In one implementation, a system for monitoring and managing an electric power grid, includes a dynamic line rating engine configured to receive time series phasor data measured at two ends of an electric power transmission line measured by synchro-phasor measurement units (PMUs), implement a heat balance equation to generate preliminary span temperatures, correct the preliminary spans temperatures to true span temperatures, and determine a line rating.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a diagram illustrating a general system including a dynamic line rating engine in accordance with an implementation.

FIG. 2 is a block diagram illustrating including a system having a dynamic line rating engine in accordance with an implementation.

FIG. 3A is a block diagram illustrating a dynamic line rating engine in accordance with an implementation.

FIG. 3B shows aspects of the calculations performed by the LineID-Spans module of FIG. 3A in accordance with an implementation.

FIG. 3C illustrates aspects of transmission line spans.

FIG. 4 illustrates a line health engine in accordance with an implementation.

FIG. 5 illustrates a flow chart of a method of providing a dynamic line rating in accordance with an implementation.

FIG. 6 illustrates, at a high-level, a strategy for converting ill-poised models into stable well-poised models in accordance with an implementation.

FIG. 7 illustrates aspects of transmission line theory.

FIGS. 8A and 8B illustrate a lumped circuit model.

FIG. 9 illustrates aspects of an example of reducing a search space in accordance with an implementation.

FIGS. 10-11 illustrates example of algorithms used to calculate transmission line parameters in accordance with an implementation.

### DETAILED DESCRIPTION

Section 1 of this disclosure describes general aspects of a system, method, and computer program product to perform dynamic line rating of electric power transmission lines based on phasor measurement data and other empirical data. A real-time determination of line rating is performed using a deterministic model that is designed to be stable and insensitive with respect to phasor noise and measurement errors. This supports accurate monitoring of transmission line parameters like ampacity and loadability, aiding utilities to make decisions regarding utility grid operation.

The ampacity is the maximum current a conductor can carry continuously without exceeding its temperature limit. The ampacity is determined by various factors like the conductor's material, size, insulation type, and the ambient temperature. Ampacity is an intrinsic thermal limit for a particular conductor—the current it can carry continuously without its own metal exceeding its allowable temperature under a defined set of weather assumptions, whereas a line rating is the operational limit for the whole transmission circuit, starting from the conductor's ampacity but then reducing it as needed to account for additional constraints such as sag-clearance, splices, clamps, insulators, terminal equipment, protection settings, and regulatory or contingency requirements; consequently, ampacity concerns only the wire, while line rating reflects the lowest permissible current across every element in the line so the entire system remains safe and compliant.

Section 1 also describes an approach that may also be applied to monitoring transmission line health to detect conditions like galloping, icing, and other problems.

The disclosed system and method are revolutionary in the electric utility industry. For typical electric power transmission line lengths and other parameters, conventional approaches to modeling transmission lines are either too simplistic and thus don't generate accurate results or result in ill-posed systems of equations in their models, meaning that they aren't stable and are extremely sensitive to noise and data measurement tolerances.

Section 2 goes into details into transmission line theory regarding a new approach developed by the inventors to convert conventional ill-posed optimization problems used in transmission line as models into well-posed equations with constraints that result in a reduced search domain and stable solutions regarding noise and measurement errors in phasor data.

The Bibliography section includes a list of references cited in the text (listed in brackets) regarding references for transmission line theory and problems in conventional techniques to calculate parameters of electric power transmission lines from phasor data).

### Deterministic, Real-Time Detection of Electric Power Transmission Line Parameters and Line Health Information from Phasor Measurement Data

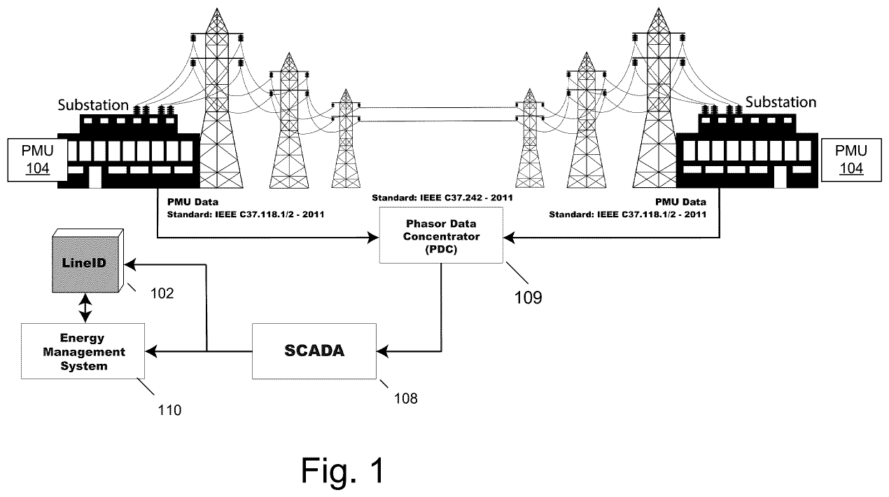

FIG. 1 is a high-level figure illustrating an example of an apparatus and system for real-time, direct, deterministic Dynamic Line Rating (DLR), called LineID. A DLR engine (hereinafter “LineID engine”) 102 leverages time series data from (synchro) Phasor Measurement Units (PMUs) 104 from both ends of an electric power transmission line. The line may have an arbitrary length, but as an example may be on the order of 20 to 50 km as an example. Each PMU may, for example, be located at a substation. As discussed below in more detail, in one implementation weather data and other data is used to estimate the temperature of spans. However, an overall system may optionally include a limited number of temperature sensors, such as in the event reliable weather data is unavailable for a local region. PMUs measure the magnitude and phase angle of AC voltage or current, as well as the frequency of the line waveform, at a specific location on a power line and generate time-stamped data using GPS, providing synchronized data. The phasor data is collected by a phasor data concentrator 109.

PMU data communication is regulated by the IEEE C37.118 standard. Additionally, the IEEE/IEC 60255-118 standard specifies the measurement, testing, and performance criteria for synchrophasors within power systems, ensuring both accuracy and compatibility for PMU data utilization across diverse applications.

The comprehensive standards governing communication protocols and PMU parameters enable the LineID engine 102 to interface seamlessly with any PMUs installed on transmission lines, irrespective of their type, nominal voltage, or length. Furthermore, these standards are adopted globally by utilities, allowing for the worldwide deployment of LineID.

A single instance of the LineID algorithm, as embodied in the LineID engine 102, logically operates over two streams of input data from two sides of a run of some segment in a power transmission system. These two sides may be represented as “SEND” and “RECEIVE” (representing the typical direction of power flow). The data schema will have a time-series of phasor data that be matched up using time stamps.

The data scheme of each side will tend to be symmetrical. Each stream is a sequence of instantaneous readings (voltage, current, phase, frequency, etc.) at a moment in time at the location of measurement. Each reading has a timestamp which uniquely identifies the time of measurement using GPS. The streams will tend to sample at known sampling rate (commonly 60 or 30 samples per second) and the underlying measurement system ensures that both SEND and RECEIVE will identify a time-aligned sample on each respective side with the same TIMESTAMP value.

For reasons which may be known or unknown, each stream may fail to include readings for certain times which under normal operation would be present. These dropouts may occur independently or bilaterally, and the LineID engine 102 must tolerate these absences.

Depending on implementation details, the PMU data is pre-processed to match up (align) samples from the same time stamps in persistent storage and deal with missing data. This may, for example, be performed at different locations in the architecture, such as by the Phasor Data Concentrator 109. Alternatively, the LineID engine 102 could perform these operations.

In one implementation, the processing of PMU samples performed on behalf of to the potential of missing data is as follows. First, the two streams of PMU data are processed in ascending time order, operating over a set time quanta which is processed as a single “frame” of data. The length of the time quanta is configurable but typical values might be 1 to 15 seconds. Second, for a given “frame”, there is a begin time (t0) and end time (t1) chosen for collecting and reading samples. This corresponds to a collection of all samples from both SEND and RECEIVE whose timestamps are between [t0, t1). Third, for all possible timestamp values between [t0, t1), there is a selection of the set for which there is a corresponding sample from both SEND and RECEIVE. Any samples for a given TIMESTAMP where a sample exists for one side and not the other is discarded. If the number of resulting “joined” samples is fewer than some minimum value (configurable, but typically 30), the processing is aborted for the current frame and continue processing future frames. Otherwise, this approach provides the resulting time-aligned data with sufficient data samples to the LineID engine 102 for computation of transmission line parameters. A process may write the resulting, derived, values so persistent storage, atomically. Without this process, the misalignment of the samples ruins the mathematical structure of the algorithm and creates huge calculation errors.

In one implementation, the Phasor Data may, for example, be made available to a Supervisory Control and Data Acquisition (SCADA) system 108 for monitoring and controlling power systems.

The LineID engine 102 accurately calculates real-time dynamic line ratings from the phasor data by estimating transmission line parameters like series resistance, inductance, shunt conductance, capacitance, and surge impedance loading (SIL) directly from PMU data. In some implementations, the LineID engine 102 also performs various calculations regarding line temperature.

The LineID engine 102 offers real-time estimates of the transmission line's stability limit (loadability), aiding utilities in maximizing line capacity while ensuring stability.

A user interface optionally supported. However, in one implementation, a LineID User Interface (UI) generates alerts, reports, and notifications of the transmission line parameters, which is provided to an energy management system 110.

The LineID approach is deterministic and enables more efficient and responsive electrical transmission network management. In one implementation, the output of the LineID engine generates a DLR.

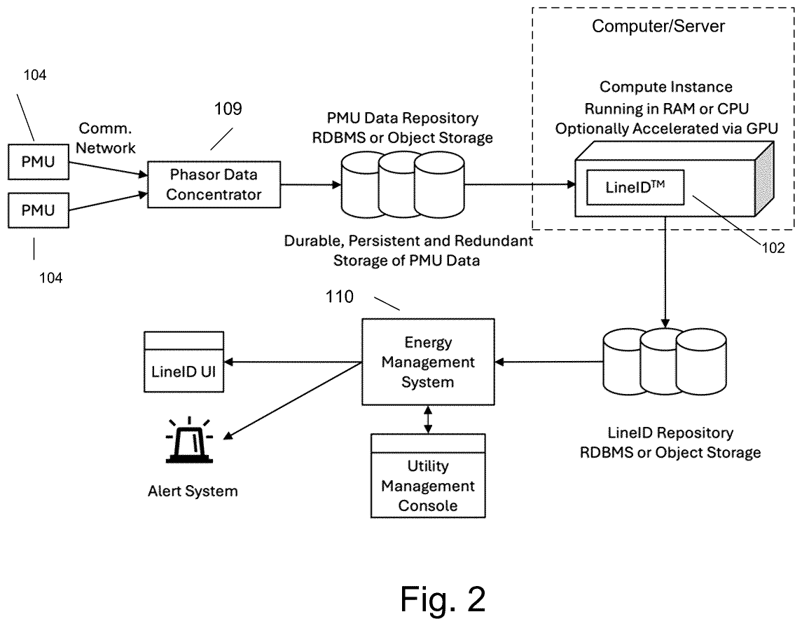

FIG. 2 illustrates an implementation in which the LineID engine 102 is implemented as computer program instructions executing as computer instance stored on a computer readable storage media and running on a CPU, such as on a computer or a server. Additional optional acceleration may be provided by a GPU. The energy management system 110 may have a utility management console, although as previously described a LineID UI May be provided. A LineID UI may be provided to generate alerts, notifications, and reports regarding the operation of the network. Note that durable, persistent, and redundant storage of PMU data may be supported. Note that LineID repository may store historical data on LineID measurements. The addition of data repositories is useful for a variety of reasons including monitoring the performance of models, improving models, etc.

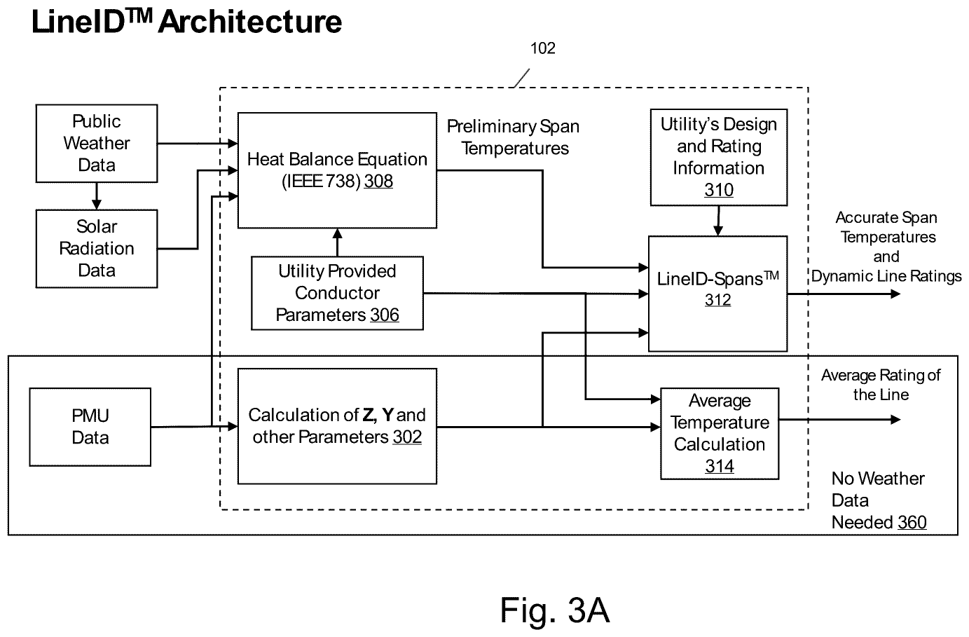

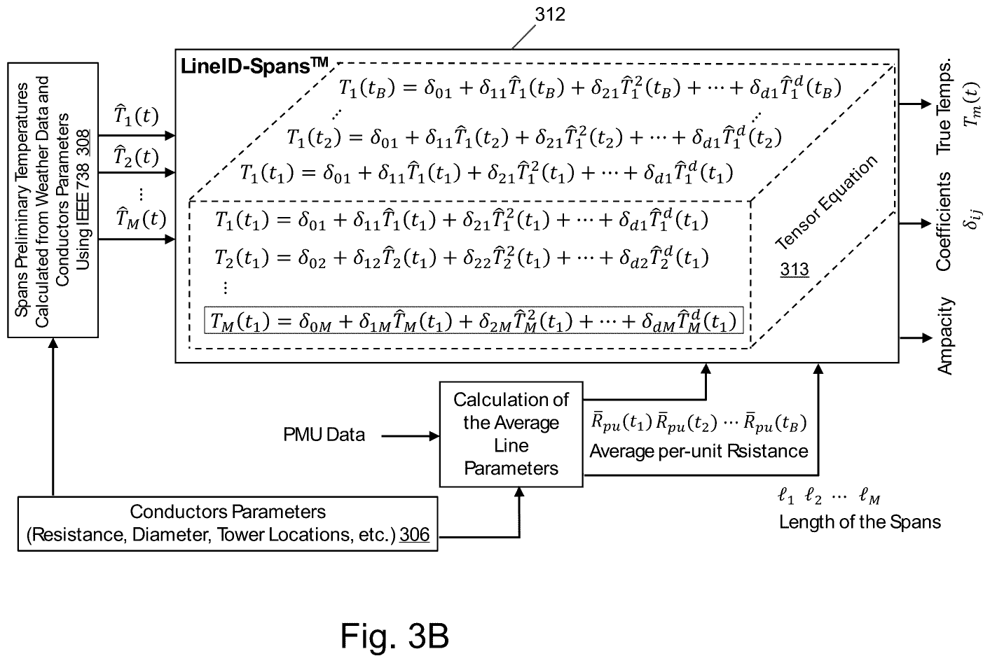

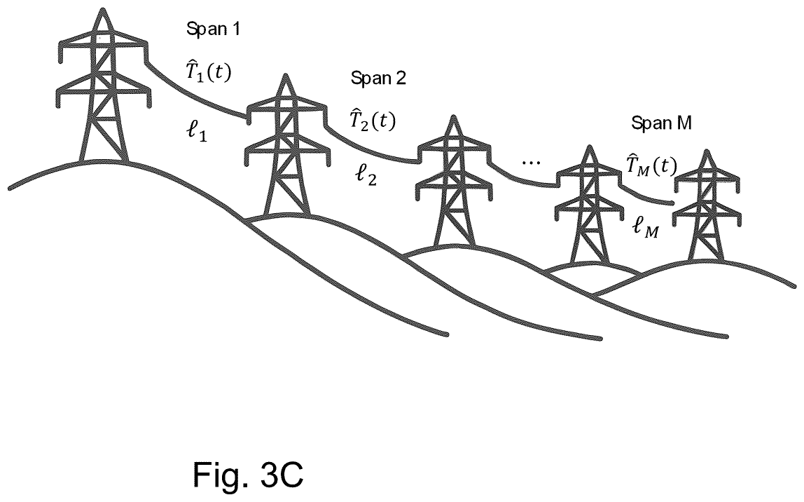

Referring to FIG. 3A, in one implementation, the LineID engine 102 has a calculation engine 302 for \tilde{Z}, and \tilde{Y} matrices (and other parameters) of the transmission line based on PMU data. The \tilde{Z} and \tilde{Y} are the overall impedance and admittance matrices of the line, respectively. This calculation, as described below in more detail, includes a model designed to be highly accurate while increasing stability by eliminating ill-posed systems of equations.

In one implementation, heat balance equations 308 is used to generate a preliminary spans temperature based on weather data, solar radiation data, and utility provided conductor parameters 306. In one implementation, a utility's transmission line design and rating information 310 may also be taken into account to generate accurate spans temperatures and ratings of the line. The average temperature of the line may also be calculated 314. In one implementation, the heat balance equations 308 are based on the IEEE 738 standard, which provides a method of calculating the temperature of overhead lines given the weather conditions. IEEE 738 provides a heat balance equation that accounts for radiative heat loss, solar heat gain, conductor parameters, estimated temperature of the conductor at the m^{th} span at time t, and the current magnitude of each phase of the conductor.

The magnitude current/is directly measured by the PMU (for a conservative assessment, we consider the magnitude current at the sending side of the transmission line). However, due to simplifications, inherent inaccuracies in the weather data, and uncertainties in the equations themselves, the preliminary spans temperature will not be the true temperature.

The LineID-Spans module 312 generates a more accurate estimate of temperature (a true temperature), which improves accuracy and addresses various estimation inaccuracies in conventional methods of calculating the current-temperature relationship based on weather conditions. In one implementation, the output of the LineID engine 102 includes the spans temperatures and the dynamic rating of the line. However, more generally, a wide variety of calculated line parameters could be output, including any parameter that can be calculated from the transmission line equations.

FIG. 3A illustrates portions of the calculations 360 not requiring weather data. Additional details of the calculation of the spans temperatures are described below in more detail in regard to FIG. 3B. FIG. 3C illustrates transmission line spans, associated span lengths, and temperatures as an aid to understanding some of the computations.

The PMU data is used to calculate \tilde{Z}, \tilde{Y}, and other parameters and may be used to calculate average line parameters, such as average resistance. As will be shown later, the real part of the \tilde{Z} matrix—the phase resistance—and the length of the line, are calculated and are used to find the average per unit resistance of the line. This average per unit resistance of the line is equal to the weighted sum of the per unit resistance of all spans.

Referring to FIG. 3C, a span is defined as the distance between two adjacent towers. The true temperatures of the spans are not directly observable without sensors. A preliminary estimate of the spans' temperatures are calculated from the weather data and the specification of the conductors, using the equations of IEEE 738. However, the true temperatures of the spans are a nonlinear function of their preliminary temperatures. Referring to FIG. 3B, the PMU data is used to calculate the electrical parameters of the conductors (\tilde{Z} and \tilde{Y} matrices, the length of the line, and average resistance per unit length). The LineID-Spans module 312 approximates a correction to the preliminary temperatures. In one implementation, the non-linear functions are approximated by a Taylor series with d-order polynomials. The order “d” of the polynomials can be chosen based on empirical data i.e., testing which order “d” works best in real-world conditions.

To find the coefficients of these polynomials, a tensor equation set 313 needs to be solved. To solve the tensor equation set, the average per-unit resistances of the lines calculated from PMU data over time is used, i.e., over “B’ measurement periods. The number of B measurement periods is selected to be sufficiently long that it is a reasonable assumption that the coefficients of the polynomials corresponding to each span a constant during time interval of “B” periods. In other words, temporal data is used to find special data by assuming that the coefficients of the polynomial corresponding to each span are constant during the time interval of “B” periods. Effectively, information over time is used to calculate an accurate estimation of the line span temperatures based on the assumption that the temperatures are constant during the calculation time interval. As discussed below in more detail, the number of B periods can be selected to achieve an accurate estimation. This is analogous to the concept of ergodicity. A key concept in ergodic theory is the notion of ergodic averages, which are time averages of a function over the system's orbit (the path it takes over time).

Generating accurate span temperatures and dynamic line ratings is a significant improvement in DLR technology. If spans of a transmission line have different temperatures, the ampacity of the line is determined by the span with the highest temperature. Thus, determining accurate span temperatures is important to improve the accuracy and reliability of the DLR line rating.

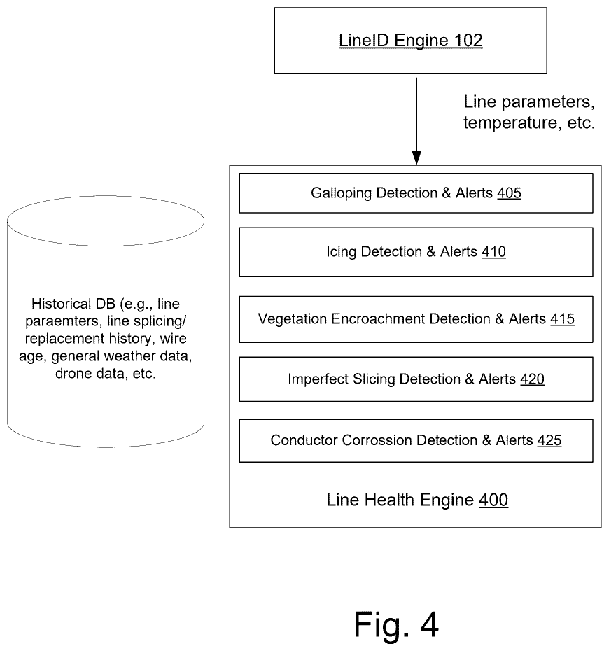

Referring to FIG. 4, the information generated by LineID engine 102 may be used by a line health engine 400. The calculation of the transmission line parameters will demonstrate observable changes over time relative to historical data when naturally occurring phenomena alter fundamental aspects of the transmission lines.

In one implementation, a galloping detection & alerts engine 405 is provided. Galloping of overhead transmission line conductors can cause noticeable changes to the line's electrical impedances because the geometry of the conductors is a key determinant of both self and mutual impedances. Under normal conditions, the line's phase conductors are arranged in a carefully designed configuration that establishes predictable inductive and capacitive coupling.

Galloping of power lines is caused by a combination of freezing rain (generating icicles) and high winds. When severe wind or ice loading triggers galloping, the resulting large-amplitude oscillations drive the conductors away from their nominal positions. As they move, the distances between conductors change in an oscillatory manner, momentarily affecting the inductance and capacitance between phases.

Because impedance is directly linked to the geometry of the conductors, any significant excursion from the intended spacing or arrangement can alter the self and mutual impedances. These fluctuations, while generally small or short-lived, can introduce temporary imbalances into the line's electrical behavior, sending it into transient periods of asymmetry before the system returns to its normal configuration.

The LineID engine 102 can calculate the impedance and admittance matrices of the line in real time; therefore, its data can be used by the line health engine 400 to detect galloping by observing the variations in these matrices as the conductors move. This real-time monitoring provides both an early warning of galloping's onset and a diagnostic tool for assessing the severity of conductor oscillations, giving system operators an opportunity to address potential mechanical and electrical impacts before they escalate.

The galloping detection and alert engine 405 may be implemented in a variety of ways, such as by collecting historical data on the response of the LineID engine 102 to galloping, using heuristic or semi-empirical models of how galloping impacts transmission line models used by the LineID engine 102 and line health engine 400, or by acquiring data to train an AI model. In any case, it is possible to classify galloping into different categories, such as low, medium, and high for generating alerts.

As galloping occurs for certain weather conditions associated with wind and ice, in some implementations weather conditions may also be taken into account.

In one implementation, an icing detection & alerts engine 410 in included. Icing on overhead transmission line conductors can cause variations in line geometry and electrical parameters that are similar in nature to those observed during galloping. As ice accumulates, the added mass changes the conductor's sag and can modify its shape. If the ice accumulation is modeled as an even distribution of ice, the sagging can be calculated from first principles for a given average weight per meter added to a given transmission line. These geometric adjustments alter inductive and capacitive coupling between phases, affecting both self and mutual impedances. Although the changes may appear gradual rather than oscillatory, the physical shift can still result in measurable deviations from the line's nominal electrical characteristics.

The ability of the LineID engine 102 to compute real-time impedance and admittance matrices allows it to detect these deviations and thus identify icing events as they develop. By monitoring incremental changes in conductor behavior, the LineID engine 102 offers early warning of mechanical stress and the potential for subsequent oscillations or other icing-related impacts on the line's reliability.

Threshold conditions for detecting icing may be determined by using models, semi-empirically or heuristically, etc. An AI model could be trained based on training data. In any case, the degree of icing on a transmission line may be classified and used to generate alerts for sections having a high degree of icing. Weather conditions may also be taken into account in making a determination icing has occurred.

In one implementation, a vegetation encroachment detection and alerts engine 415 is included. In much of North America, a growing tree can add one-to-three feet in height per year depending on the tree species and location. However, some trees in tropical rainforests can grow up to 10 feet per year in height. Trees also grow laterally in width. Some types of bamboo can grow 20 feet in a single year. The point is that vegetation can encroach on electric power lines.

Vegetation encroachment can cause deviations in the electrical characteristics of a transmission line by altering the effective geometry of the line and its surroundings. As vegetation grows closer to the conductors, it can reduce clearances or introduce nearby conductive or dielectric objects, shifting the line's electromagnetic environment. Even small changes in conductor-to-ground or conductor-to-vegetation spacing can affect the line's inductive and capacitive coupling, leading to measurable variations in both self and mutual impedances. Because LineID engine 102 computes the line's impedance and admittance matrices in real time, the LineID engine 102 and line health engine 400 can detect these subtle changes and alert operators to encroachment issues before they become severe. This real-time insight helps maintain safe clearances and reduces the risk of flashovers or other reliability concerns associated with vegetation growth. For example, over the course of one or more years, a gradual change in transmission line parameters may indicate the encroachment of vegetation.

Thresholds for identifying vegetation encroachment concerns may be selected based, for example, semi-empirically or heuristically, such as being based on empirical data of sections of a transmission line suffering from vegetation encroachment. In one implementation, the UI displays the changes directly. Alternatively, heuristics could be used to generate a display indicating likely vegetation encroachment. Such information may be useful, for example, for a power company to prioritize sections of a transmission line for inspection and pruning of trees and other vegetation.

In one implementation, an imperfect splice detection and alerts engine 420 is included. Transmission lines are often spliced, such as after a section of the transmission line breaks during a storm. An imperfect splice of a transmission line often introduces a slight increase in the conductor's resistance due to poor contact or compromised conductor material at the joint. This added resistance, though localized, can still alter the line's overall electrical signature enough to be detected when measuring the conductor's impedance and admittance in real time. By focusing on the real (resistive) component of the line parameters, the LineID engine 102 and line health engine 400 can identify even minor deviations from the expected resistance profile, signaling the presence of a flawed splice.

Such early detection is critical for preventing localized heating, conductor damage, and other issues that might otherwise remain hidden until the splice deteriorates further, risking catastrophic events and wildfires. For example, the resistive component of a transmission line section can be compared before and after a splice. Moreover, given that a splice can deteriorate over time, the resistive component can be monitored for each line after a splice. That is, a threshold resistive component is one possible indicator of imperfect splicing but so is an increase, over time, in the resistive component. For example, a threshold level of the resistive component and a threshold time rate of change could be selected based on various criteria, including a historical database of examples of imperfect splicing. In one implementation, the UI generates an analytical display and alerts of potential line splicing imperfections.

In one implementation, a conductor corrosion detection and alerts engine 425 is included. Over time, environmental exposure can cause the metal of the conductors of a transmission line to degrade, resulting in increased resistance at the corroded sections. Unlike abrupt mechanical failures, corrosion tends to develop gradually, and its progression may be detected as a slow change in the real (resistive) component of the impedance. By continuously monitoring the impedance and admittance matrices in real time, the LineID engine and line health engine 400 can identify these subtle shifts before they evolve into critical failures.

Early detection of corrosion not only facilitates timely maintenance but also plays a vital role in preventing catastrophic events, such as unexpected outages or wildfires, which could be triggered by the additional heating and mechanical weakness associated with corroded conductors. Note that the conductor corrosion detection can occur in sections of a transmission line that have not been recently spliced. That is, a gradual increase in corrosion can be distinguished from an imperfect splice.

It will be understood that the line health engine 400 may be integrated with the LineID engine 102 to provide both LineID information and line health information. However, it will be understood that some customers may desire only the line health engine. Thus, in some implementations, the functionality of the LineID engine 102 is integrated into the line health engine 400 in terms of providing information on the line health engine needs.

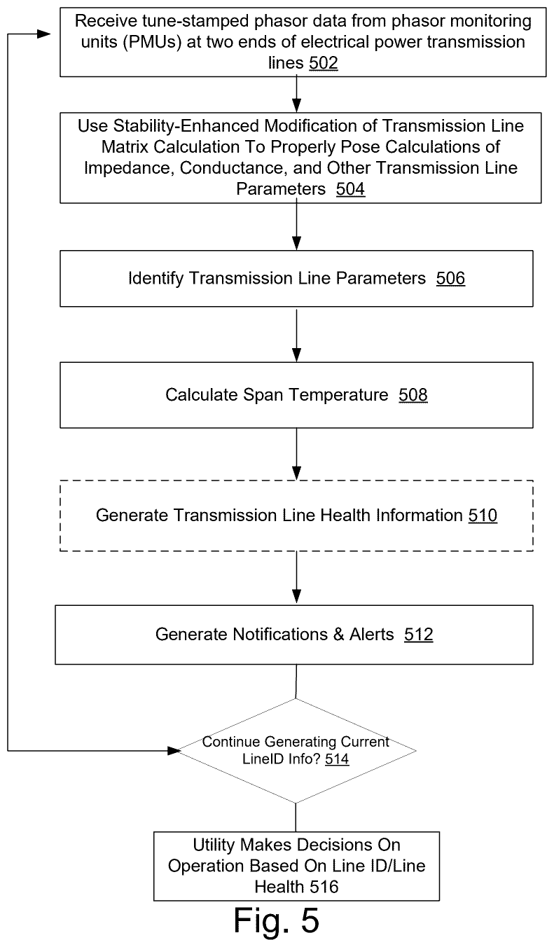

FIG. 5 is a flow chart in accordance with an implementation, illustrating looping. In block 502, time stamped phasor data is received. In block 504, a stability-enhanced modification of transmission line equations that is properly posed is used to calculate various transmission line parameters. In block 506 the transmission line parameters are generated, such as \tilde{Z} and Ý matrices. In block 508, span temperature data is calculated. In block 510, transmission line health information is generated for options supporting this feature. The loop as previously discussed may be performed dynamically in real time to generate alerts and updates 512. The process may be repeated in a loop 514 unless otherwise discontinued. The alerts and updated may be considered by a utility in making decisions 516 for the operation of an electrical grid.

### I. Converting Transmission Line Optimization Problems into Well-Posed Problems with Reduced Search Space Robust to Noise and Data Tolerances

As utilities are interested in squeezing as much capacity out of existing transmission lines as possible in view of changing ambient conditions, reliable and accurate calculations of transmission line parameters are particularly important.

However, conventional transmission line modeling techniques cannot be directly used to reliably and accurately determine line parameters from phasor data due to a variety of issues, including sensitivity to noise and data tolerances. The conventional approach for calculating \tilde{Z} and \tilde{Y} matrices for an electric power transmission line results in an optimization problem that is ill-posed. An example of a methodology developed specifically for the LineID Engine 102 to accurately and reliably perform calculations of \tilde{Z} and \tilde{Y} matrices is now described.

The model implemented by the \tilde{Z} and \tilde{Y} transmission line parameter calculator 302 has to address a variety of issues. Conventional linear equation optimization techniques used to determine the \tilde{Z} and \tilde{Y} matrices are susceptible to noise and measurement tolerances. The reason for this is that conventional impedance (\tilde{Z}) and admittance (\tilde{Y}) admittance matrix equations are ill-posed, meaning they are susceptible to noise and measurement uncertainties. They have high variability and they can fail to converge to an acceptable solution.

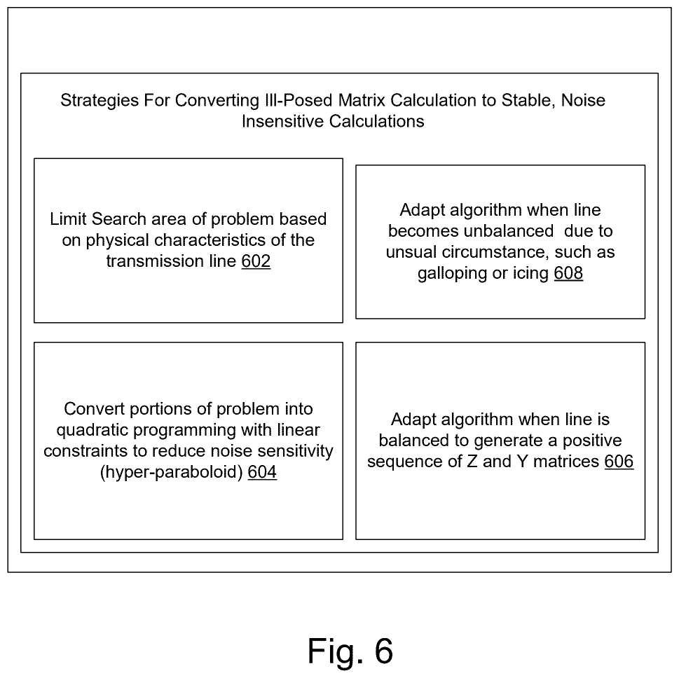

To address this, referring to FIG. 6, a novel approach constrains the optimization algorithm to a smaller search domain 602 where the correct solution exists. Other tricks include strategic pre-scaling and converting portion of the optimization problems into quadratic programming 604 with linear constraints to reduce noise sensitivity. Still other strategies adapting the strategy based on whether the line unbalanced 608 or balanced 606.

### II. Overview of the Theory of Multiconductor Transmission Lines

In this section, we briefly discuss the theory of multi-conductor transmission lines, and we highlight important equations governing the behavior of voltage and current phasors at both sides of the transmission line measured by PMUs.

a. Partial Differential Equations of Multi-Conductor Transmission Lines

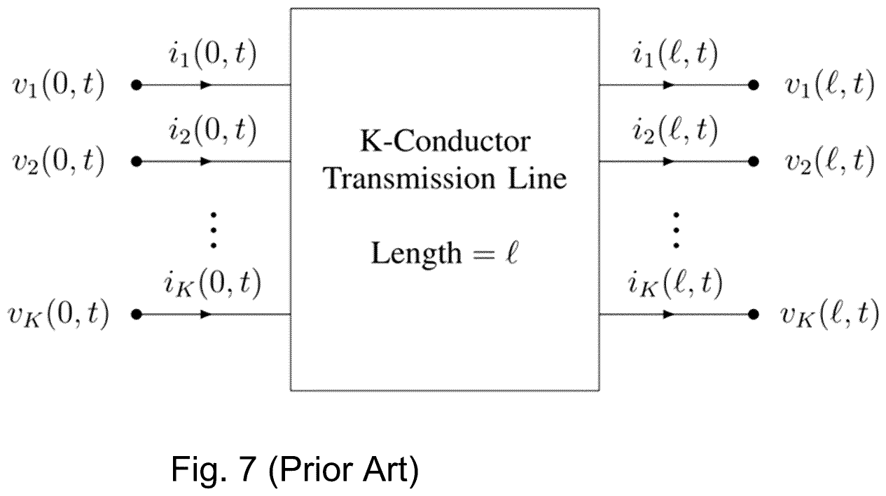

FIG. 7 illustrates the block diagram of a K-conductor transmission line and its voltages and currents at both ends. Voltage and currents of a multi-conductor transmission line are governed by the following differential equations:

$$- \frac{\partial }{\partial z} v ( z , t ) = R i ( z , t ) + L \frac{\partial }{\partial t} i ( z , t ) , \qquad ( 2.1 )$$

$$- \frac{\partial }{\partial z} i ( z , t ) = G v ( z , t ) + C \frac{\partial }{\partial t} v ( z , t ) ,$$

where v=[v₁(z, t), v₂(z, t), . . . V_{K}(z, t)]^{T}, i=[i₁(z, t), i₂(z, t), . . . i_{K}(z, t)]^{T}, R, L, G, and Care the voltage vector containing the voltages of the K conductors of the transmission line at the distance z and time t, the current vector containing the currents of the K conductors of the transmission line at the distance z and time t, the K×K per unit resistance, inductance, conductance and capacitance matrices, respectively.
b. Properties of the Matrices

Matrices R, L, G, and C have several properties for a lossy and homogeneous medium. The assumption that the line is homogeneous comes from the fact that the overhead transmission lines are far from ferromagnetic materials, and we assume that the air is homogeneous around the conductors and slight deviations from these conditions are negligible. The properties that matrices R, L, G, and C possess in a lossy and homogeneous medium are as follows (Paul, 2007):
1. The matrices R, L, G, and C are real and symmetric.
2. All entries of matrices R and L are nonnegative:

$$R \geq 0 , L \geq 0 \qquad ( 2.2 )$$

3. The diagonal entries of matrices G, and C are all positive and their off-diagonal entries are all negative.
4. The matrices G, and C are hyperdominant, i.e., the sum of all entries in any row or column is greater than zero:

$$C 1 = {1}^{T} C > 0 \qquad ( 2.3 )$$

$$G 1 = {1}^{T} G > 0 ,$$

where 1 is a column vector with all entries equal to one.
5. The matrix L is diagonally dominant due to the fact that the series inductance associated with each individual conductor is larger than the sum of mutual inductances between that specific conductor and all other conductors.
6. The matrices G, and C also satisfy the following equations:

$$G = \frac{σ}{ε} C , \qquad ( 2.4 )$$

where σ and ε are the conductivity and permittivity of air, respectively. Since

$$\frac{σ}{ε} ≃ 1 {0}^{- 4} {s}^{- 1} ,$$

we can assume that G≅0.
7. In case of a three-conductor balanced and transposed transmission line, the entries of the series impedance matrix of the line or Z=R+jωL are defined as [13]:

$${Z}_{n n} ≃ {R}_{n} + j ω \frac{{μ}_{0}}{2 π} ln ( \frac{{h}_{n n}}{r} ) Ω / m , r = GMR of the conductor \qquad ( 2.5 )$$

$${Z}_{n m} ≃ j ω \frac{{μ}_{0}}{2 π} ln ( \frac{{h}_{n m}}{{D}_{e q}} ) Ω / m , {D}_{e q} = \sqrt[3]{{D}_{12} {D}_{13} {D}_{23}} \qquad ( 2.6 )$$

where, Zₙₙ is the series self-impedance of conductor n, Zₙₘ is series mutual impedance between conductor n and conductor m, Rₙ is the series resistance of conductor n, r is the geometric mean radius (GMR) of conductor n, D_{eq} is the equivalent distance between conductors n and m (their Geometrical Mean Distance (GMD)), μ₀ is the permeability of air, hₙₙ is the distance between the conductor n and its mirror image, and hₙₘ is the distance between the conductor n and the mirror image of conductor m.
It should be noted that in case of a fully balanced and transposed line, the per unit phase inductance of the line is constant along the line (see equation (3.24)).

In case of unbalanced and/or untransposed line, we can use Modified Carlson's Equations to find the entries of Z (Kersting & Kerestes, 2022).

Since matrices L, G, and C are real and symmetric, their eigenvalues are real. Moreover, the matrices G, and C are symmetric hyperdominant matrices and the matrix L is diagonally dominant; therefore, according to Gershgorin Circle Theorem (P. Lancaster and M. Tismenetsky, 1985), all eigenvalues of L, G, and C are nonnegative. This proves that the matrices L, G, and C are also positive semidefinite.

c. Frequency-Domain Equations for Per-Unit Length Parameters
In high-voltage overhead transmission lines, there are usually three live conductors. The voltages and currents of the conductors are sinusoidal with a frequency either 60 Hz or 50 Hz. Denote the voltages and currents of the kth conductors as follows:

$${v}_{k} ( z , t ) = {V}_{k} ( z ) cos [ ω t + {ϕ}_{k} ( z ) ] = \{ {\overline{V}}_{k} ( z ) {e}^{j ω t} \} , \qquad ( 2.7 )$$

$${i}_{k} ( z , t ) = {I}_{k} ( z ) cos [ ω t + {θ}_{k} ( z ) ] = \{ {\overline{I}}_{k} ( z ) {e}^{j ω t} \}$$

$${\overline{V}}_{k} ( z ) = {V}_{k} ( z ) {e}^{j {ϕ}_{k} ( z )}$$

$${\overline{I}}_{k} ( z ) = {I}_{k} ( z ) {e}^{j {θ}_{k} ( z )}$$

where ω is the frequency of the sinusoid, ϕₖ(z) and θₖ(z) are the phases of the sinusoids, Vₖ(z) and Iₖ(z) are the amplitudes of the sinusoids and V̅ₖ(z) and Īₖ(z) are the phasor representations of the sinusoids.

By using the phasor representations of equation (2.7) in equation (2.1) we can derive the following differential equations governing the phasor values of voltages and currents versus the distance z.

$$\frac{d}{d z} \overline{V} ( z ) = - Z \overline{I} ( z ) , \qquad ( 2.8 )$$

$$\frac{d}{d z} \overline{I} ( z ) = - Y \overline{V} ( z ) ,$$

$$where$$

$$Z = R + j ω L , \qquad ( 2.9 )$$

$$Y = G + j ω C ,$$

$$and \overline{V} = {[ {\overline{v}}_{1} ( z ) , {\overline{v}}_{2} ( z ) , … {\overline{v}}_{K} ( z ) ]}^{T} , \overline{I} = {[ {\overline{ι}}_{1} ( z ) , {\overline{ι}}_{2} ( z ) , … {\overline{ι}}_{K} ( z ) ]}^{T} .$$

The Chain-Parameter Matrix (CPM) Φ(z) (also known as the transition matrix or ABCD matrix) that relates the voltage and current phasors at z=0 and z can be found by solving equation (2.8) as explained in (Paul, 2007):

$$[ \begin{matrix}\overline{V} ( z ) \\ \overline{I} ( z )\end{matrix} ] = Φ ( z ) [ \begin{matrix}\overline{V} ( 0 ) \\ \overline{I} ( 0 )\end{matrix} ] = [ \begin{matrix}cosh ( Γ z ) & - sinh ( Γ z ) {Z}_{C} \\ - {Y}_{C} sinh ( Γ z ) & {Y}_{C} cosh ( Γ z ) {Z}_{C}\end{matrix} ] [ \begin{matrix}\overline{V} ( 0 ) \\ \overline{I} ( 0 )\end{matrix} ] , \qquad ( 2.1 )$$

$$Γ = \sqrt{ZY}$$

where the characteristic impedance of the line Z_{C} is defined as

$${Z}_{C} = {Y}_{C}^{- 1} = {Γ}^{- 1} Z = Γ {Y}^{- 1} = \sqrt{Z {Y}^{- 1}} . \qquad ( 2.11 )$$

The inverse of matrix Φ(z) can easily be found:

$${Φ}^{- 1} ( z ) = Φ ( - z ) = [ \begin{matrix}cosh ( Γ z ) & sinh ( Γ z ) {Z}_{C} \\ {Y}_{C} sinh ( Γ z ) & {Y}_{C} cosh ( Γ z ) {Z}_{C}\end{matrix} ] \qquad ( 2.12 )$$

d. Lumped Circuit Model

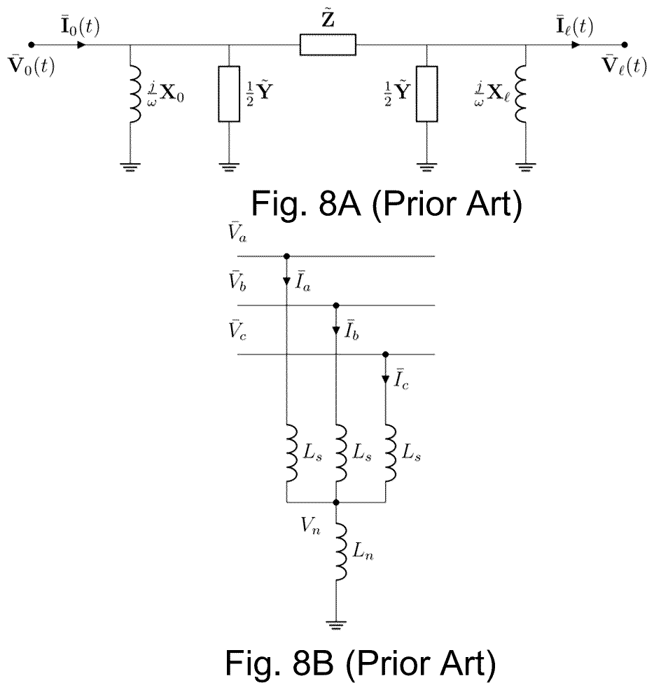

We can approximate the transmission line with an equivalent lumped circuit model (LCM). FIG. 8A is an equivalent lumped circuit model of a transmission line with shunt reactors. FIG. 8B is the circuit model of a shunt reactor. A This model is also called the equivalent π model. We assume that the system is three phases, i.e., K=3.

The current Ī₀(t), and Ī [symbol] (t), are respectively the three phase currents at nodes 0 (z=0) and [symbol] (z= [symbol] ) and V̅₀(t), and V̅ [symbol] (t), are respectively the three phase voltages at nodes 0 (z=0) and [symbol] (z= [symbol] ) at time t. The inductors in the figure are the shunt reactors at both sides of the transmission line. They may or may not be energized. Their admittances are

$$j \frac{1}{ω} {X}_{0} and j \frac{1}{ω} {X}_{ℓ} ,$$

where X₀, [symbol] ∈ [symbol] . To define the matrices X₀ and X [symbol] , we use the circuit model of a shunt reactor illustrated in FIG. 2b. The admittance of a shunt reactor is defined by:

$$X = [ \begin{matrix}{X}_{1} & {X}_{2} & {X}_{2} \\ {X}_{2} & {X}_{1} & {X}_{2} \\ {X}_{2} & {X}_{2} & {X}_{1}\end{matrix} ] , {X}_{1} = {( \frac{{L}_{s}^{2}}{{L}_{n}} + 3 {L}_{s} )}^{- 1} - {L}_{s}^{- 1} , {X}_{2} = {( \frac{{L}_{s}^{2}}{{L}_{n}} + 3 {L}_{s} )}^{- 1} , \qquad ( 2.13 a )$$

$${L}_{n} = \frac{{X}_{2}}{{X}_{1} {X}_{2} - 2 {X}_{2}^{2} + {X}_{1}^{2}} , {L}_{s} = \frac{1}{{X}_{2} - {X}_{1}} . \qquad ( 2.13 b )$$

It can be seen in equation (2.13) that X₁≤0 and X₂≥0. Moreover, \tilde{Y} is the overall admittance matrix of the transmission line, which has been split between both ends, and \tilde{Z} is the overall impedance matrix of the entire line.

If the shunt reactors only contain phase reactors (inductances connected to ground) then X₀₂ and [symbol] will be zero. In case where there is neutral reactor between phase reactors and ground, X₀₂ and [symbol] will not be zero. In any case, we will consider that the neutral reactor exits. The equations governing the circuit for a three-phase transmission line are:

$${\overline{I}}_{0} ( t ) = \frac{1}{2} \tilde{Y} {\overline{V}}_{0} ( t ) + j \frac{1}{ω} {X}_{0} {\overline{V}}_{0} ( t ) + {\tilde{Z}}^{- 1} ( {\overline{V}}_{0} ( t ) - {\overline{V}}_{ℓ} ( t ) ) , \qquad ( 2.14 )$$

$${\overline{I}}_{ℓ} ( t ) = - \frac{1}{2} \tilde{Y} {\overline{V}}_{ℓ} ( t ) - j \frac{1}{ω} {X}_{ℓ} {\overline{V}}_{ℓ} ( t ) + {\tilde{Z}}^{- 1} ( {\overline{V}}_{0} ( t ) - {\overline{V}}_{ℓ} ( t ) ) ,$$

$${\overline{V}}_{m} ( t ) = {[ {\overline{V}}_{m a} ( t ) , {\overline{V}}_{m b} ( t ) , {\overline{V}}_{m c} ( t ) ]}^{T} , m ∈ \{ 0 , ℓ \}$$

$${\overline{I}}_{m} ( t ) = {[ {\overline{I}}_{m a} ( t ) , {\overline{I}}_{m b} ( t ) , {\overline{I}}_{m c} ( t ) ]}^{T} , m ∈ \{ 0 , ℓ \}$$

The CPM of the lumped circuit model of the transmission line can be shown to be:

$$[ \begin{matrix}{\overline{V}}_{ℓ} ( t ) \\ {\overline{I}}_{ℓ} ( t )\end{matrix} ] = {\tilde{Φ}}_{lu} [ \begin{matrix}{\overline{V}}_{0} ( t ) \\ {\overline{I}}_{0} ( t )\end{matrix} ] = [ \begin{matrix}{I}_{3} + \frac{1}{2} \tilde{Z} \tilde{Y} & - \tilde{Z} \\ - \tilde{Y} - \frac{1}{4} \tilde{Y} \tilde{Z} \tilde{Y} & {I}_{3} + \frac{1}{2} \tilde{Y} \tilde{Z}\end{matrix} ] [ \begin{matrix}{\overline{V}}_{0} ( t ) \\ {\overline{I}}_{0} ( t )\end{matrix} ] , \qquad ( 2.15 )$$

where I₃ is the 3×3 identity matrix and X₀= [symbol] =0 (shunt reactors are not energized). If the length of the transmission line is much smaller than the wavelength of the sinusoidal wave transmitted through it, the lumped circuit model would be accurate. In north America the frequency of the sinusoids is 60 Hz and consequently, the wavelength is 5000 km. Therefore, for transmission lines shorter than 250 km the lumped circuit model would be accurate.

Regardless of the length of the transmission line, the following equations hold true by comparing equation (2.15) and equation (2.10):

$$cosh ( Γℓ ) = {I}_{3} + \frac{1}{2} \tilde{Z} \tilde{Y} \qquad ( 2.16 )$$

$$sinh ( Γℓ ) {Z}_{C} = \tilde{Z}$$

$${Y}_{C} sinh ( Γℓ ) = \tilde{Y} + \frac{1}{4} \tilde{Y} \tilde{Z} \tilde{Y}$$

$${Y}_{C} cosh ( Γℓ ) {Z}_{C} = {I}_{3} + \frac{1}{2} \tilde{Y} \tilde{Z} .$$

If the length of the transmission line is less than 250 km, we have \tilde{Φ}ₗᵤ≅Φ( [symbol] ), \tilde{Z}≅Z [symbol] and \tilde{Y}≅Y [symbol] .

In the following sections, we will discuss a new method to directly calculate \tilde{Z} and \tilde{Y}. Regardless of the length of the transmission line, the results would represent the true parameters of the transmission line. If the transmission line is short, Φₗᵤ≅Φ( [symbol] ), \tilde{Z}≅Z [symbol] and \tilde{Y}≅Y [symbol] are correct. Otherwise, they are not. In any case, equation (2.15) is always true.

### III. Calculating \tilde{Z} and \tilde{Y} from Voltage and Current Phasors Time Series

The goal here is to calculate the matrices \tilde{Z} and \tilde{Y} by using the voltage and current phasor time-series. Since the equations of the lumped circuit model are all linear, they can be rearranged into a linear matrix equation so that the unknowns are the entries of the matrices \tilde{Z} and \tilde{Y} and the observations and the coefficient matrix are constructed by the voltage and current phasors time-series. This arrangement will create a highly ill-posed system of equations that are very difficult to solve. In the following paragraphs, the highly ill-posed nature of the equations and how to overcome this problem are explained.

The voltage phasor time-series at both ends of the transmission line are highly correlated to each other, because the impedances of the lines are very small over typical electrical power transmission line lengths. This makes the matrices, created from concatenating the voltage and current phasor time-series, highly ill-posed.

Another factor that contributes to the ill-posed nature of the time-series matrices is that the first two terms of the right-hand side of the equations (2.14) are much bigger than the third term because the magnitudes of the voltage phasors V̅₀(t) and [symbol] (t) are much bigger than the magnitude of their difference [symbol] (t)−V̅₀(t). This imbalance between the magnitudes will create a linear matrix equation where the matrix has columns with very large numbers and columns with much smaller numbers. This situation makes the ill-posed condition of the linear equation worse.

Without extra constraints, solving equation (2.14) directly will result in very unstable and noisy solutions The most recent methods used in the prior art to solve the equations include Tikhonov regularization (Sitzia, Muscas, Pegoraro, Solinas, & Sulis, 2022), weighted least squares assuming the noise of the PMUs are Gaussian and their standard deviations are known or estimated (Wehenkel, Mukhopadhyay, Le Boudec, & Paolone, 2020), (Pegoraro P. A., Sitzia, Solinas, & & Sulis, PMU-based estimation of systematic measurement errors, line parameters, and tap changer ratios in three-phase power systems, 2022), (Pegoraro P. A., Sitzia, Solinas, & Sulis, 2022), robust least-squares (Milojević, Čalija, Rietveld, Ačanski, & Colangelo, Utilization of PMU measurements for three-phase line parameter estimation in power systems, 2018), ignoring off-diagonal entries of impedance and admittance matrices Y and Z to make the equations easy to solve (Singh, Cobben, & & Ćuk, PMU-based cable temperature monitoring and thermal assessment for dynamic line rating, 2020) (Du & Liao, 2012), forming nonlinear equations and solving them using either linearization or nonlinear optimizations method (Bendjabeur, Kouadri, & Mekhilef, 2020) (Vicol, 2014) (Borda, Olarte, & Diaz, 2009), calculating only positive sequence impedance and admittance matrices (Du & Liao, 2012) (Wang, Centeno, Jones, & Yang, Transmission lines positive sequence parameters estimation and instrument transformers calibration based on pmu measurement error model, 2019), performing statistical analysis to remove the noise (Zhao, et al., 2015), finding the errors in the parameter models (Khalili & Abur, 2021), and using the typical values of parameters from the data sheet of cable manufacturers to form restrictive constraints (Zhou, Zhao, Shi, Zhao, & Jing, 2015). None of these methods has been able to fully mitigate the ill-posed nature of the equations and they all require some kind of optimization with regularization or simplification in the equations that cannot effectively solve the equations. In (Zhou, Zhao, Shi, Zhao, & Jing, 2015), the typical values of parameters from data sheets could not represent the actual values in the field and can lead to incorrect estimation of the parameters.

To mitigate the ill-posed condition of the equations, we can use the properties of the R, L, C discussed in Section-II.b to add constraints to equation (2.14). We will start calculating the matrix \tilde{C}.

a. Calculating Matrix Õ

To start, we define time-series as matrices whose columns represent the values of their parameters at each moment (sample) of time. This can be shown as:

$$\begin{matrix}{\overline{V}}_{0} = [ {\overline{V}}_{0} ( {t}_{0} ) , {\overline{V}}_{0} ( {t}_{1} ) , … , {\overline{V}}_{0} ( {t}_{N - 1} ) ] ∈ , \\ {\overline{I}}_{0} = [ {\overline{I}}_{0} ( {t}_{0} ) , {\overline{I}}_{0} ( {t}_{1} ) , … , {\overline{I}}_{0} ( {t}_{N - 1} ) ] ∈ , \\ {\overline{V}}_{ℓ} = [ {\overline{V}}_{ℓ} ( {t}_{0} ) , {\overline{V}}_{ℓ} ( {t}_{1} ) , … , {\overline{V}}_{ℓ} ( {t}_{N - 1} ) ] ∈ , \\ {\overline{I}}_{ℓ} = [ {\overline{I}}_{ℓ} ( {t}_{0} ) , {\overline{I}}_{ℓ} ( {t}_{1} ) , … , {\overline{I}}_{ℓ} ( {t}_{N - 1} ) ] ∈ ,\end{matrix} \qquad ( 3.1 )$$

where N is the number of time samples. Then by considering equation (3.1), we add the equations in (2.14) to eliminate Z̅.

$$- {Σ}_{I} = \frac{1}{2} \tilde{Y} {Σ}_{V} + j \frac{1}{ω} {X}_{0} {\overline{V}}_{0} + j \frac{1}{ω} {X}_{ℓ} {\overline{V}}_{ℓ} , {Σ}_{V} = {\overline{V}}_{0} + {\overline{V}}_{ℓ} , {Σ}_{I} = - {\overline{I}}_{0} + {\overline{I}}_{ℓ} , \qquad ( 3.2 )$$

$$where$$

$$Z = R + j ω L , Y = j ω C , G ≃ 0. \qquad ( 3.3 )$$

By using equation (3.3) and rearranging equation (3.2) we can come up with the following equation:

$${H}_{y} {h}_{y} = {d}_{y} , {H}_{y} ∈ , {h}_{y} ∈ , {d}_{y} ∈ , \qquad ( 3.4 )$$

where H_{y} is a matrix comprises values of the voltage phasors V̅₀ and V̅ [symbol] , d_{y} is a vector comprises values of the current phasors Ī₀ and [symbol] and h_{y} is a vector comprises the unknown parameters \tilde{C}, X₀ and X [symbol] . As explained before, the matrix H_{y} is highly ill-posed, which means that the existence of slight noise in the vector d_{y} will result in a huge variability in the solution.

To remedy this problem, we need to include constraints that arise from the properties of \tilde{C} explained in Section II.b. The entries of H_{y} are very large because they are formed by the voltages as can be seen in equation (3.2). These very large values can cause instability in the optimization. To avoid the instability, we can pre-scale H_{y} by its maximum value so the values of the matrix H_{y} are not very large. Let the pre-scaled version of H_{y} be H′_{y}. Then the solution can also be normalized in a similar manner to maintain the correct scaling at the results. This pre-scaling can be performed by defining the following change of variable in equation (3.4):

$${h}_{y} = \frac{{h}_{y}^{′}}{max \{ {H}_{y} \}} , \qquad ( 3.5 )$$

where h′_{y} is the pre-scaled solution of equation (3.4).

Now, we need to find other constraints that would help solve equation (3.4). The constraint on h′_{y} can be defined as:

$${Eh}_{y}^{′} \leq 0 , \qquad ( 3.6 )$$

$$where$$

$$E = [ \begin{matrix}{E}_{1} & {0}_{6 \times 2} & {0}_{6 \times 2} \\ {E}_{2} & {0}_{3 \times 2} & {0}_{3 \times 2} \\ {0}_{2 \times 6} & {E}_{3} & {0}_{2 \times 2} \\ {0}_{2 \times 6} & {0}_{2 \times 2} & {E}_{3}\end{matrix} ] \qquad ( 3.7 )$$

$${E}_{1} = diag \{ - 1 , 1 , 1 , - 1 , 1 , - 1 \} , {E}_{2} = [ \begin{matrix}- 1 & - 1 & - 1 & 0 & 0 & 0 \\ 0 & - 1 & 0 & - 1 & - 1 & 0 \\ 0 & 0 & - 1 & 0 & - 1 & - 1\end{matrix} ] , {E}_{3} = [ \begin{matrix}1 & 0 \\ 0 & - 1\end{matrix} ] . \qquad ( 3.8 )$$

The matrix E₁ enforces the sign constraints as explained in the third property in Section II.b. On the other hand, the matrix E₂ enforces that sum of the row or columns of the matrix \tilde{C} is nonnegative (the matrix is hyperdominant). Moreover, the matrix E₃ enforces equation (2.13), i.e., X₀₁≤0, X₀₂ ≥0, [symbol] ≤0, [symbol] ≥0.

To complete the problem, instead of solving the equation (3.6), we will find ĥ′_{y}(ξ) by minimizing ∥H′_{y}h′_{y}−d_{y}∥₂², which is equivalent to minimizing

$${( {h}_{y}^{′} )}^{T} {( {H}_{y}^{′} )}^{T} {H}_{y}^{′} {h}_{y}^{′} - 2 {d}_{y}^{T} {H}_{y}^{′} {h}_{y}^{′}$$

(the term

$${d}_{y}^{T} {d}_{y}$$

has been removed because it is a constant number). Therefore, the problem becomes a quadratic programming with linear constraints:

$$\begin{matrix}{min}_{{h}_{y}^{′}} \\ s . t .\end{matrix} \begin{matrix}{( {h}_{y}^{′} )}^{T} {( {H}_{y}^{′} )}^{T} {H}_{y}^{′} {h}_{y}^{′} - 2 {d}_{y}^{T} {H}_{y}^{′} {h}_{y}^{′} \\ {Eh}_{y}^{′} \leq 0 ,\end{matrix} \qquad ( 3.9 )$$

It should be noted that the matrix (H′_{y})^{T}H′_{y} is positive semidefinite; therefore, the objective function of the optimization problem equation (3.9) is convex. There are 10 variables in the optimization problem equation (3.9) (h′_{y}∈ [symbol] ). The constraints associated to E₁ and E₃ will force the solution to be in one of the 210 orthants of the 10-dimensional space. The objective function of the optimization is a hyper-paraboloid whose minimum is at the origin in a 11-dimensional space (the extra dimension is the height of the hyper-paraboloid) and the constrains associated to E₂ represent a polyhedron in the orthant define by E₁ and E₃.

The point where the polyhedron touches the hyper-paraboloid is the solution. This solution always exists because the hyper-paraboloid is always centered around the origin and the polyhedron always does not include the origin (it is impossible that all admittances and impedances are zero). Thus, the center of the hyper-paraboloid is always outside the polyhedron. FIG. 7 shows a two-dimensional render of the contour plot of the objective function and the polyhedron representing the constraints. The contour plot of the objective function (hyper-paraboloid) and the polyhedron representing the constraints. The origin and the solution are illustrated.

We know that the center of the hyper-paraboloid represented by

$${‖ {H}_{y}^{′} {h}_{y}^{′} - {d}_{y} ‖}_{2}^{2} = {( {h}_{y}^{′} )}^{T} {( {H}_{y}^{′} )}^{T} {H}_{y}^{′} {h}_{y}^{′} - 2 {d}_{y}^{T} {H}_{y}^{′} {h}_{y}^{′} + {d}_{y}^{T} {d}_{y} . \qquad ( 3.1 )$$

is at (H′_{y})^{†}d_{y}, where † is the symbol of Moore-Penrose pseudo-inverse. A small error in d_{y} will cause a significant shift in the center of this hyper-paraboloid (because H′_{y} is an ill-posed matrix) and as a result, the solution will be dramatically shifted. By removing the term in

$${d}_{y}^{T} {d}_{y}$$

in equation (3.10), we make the center of the hyper-paraboloid totally independent to the errors in d_{y} (the center of the hyper-paraboloid would be always at the origin as stated before). The objective function in equation (3.9) depends on d_{y} only in the second term, and the errors in d_{y} only affect the direction of the axes of the hyper-paraboloid. Small variations in the direction of the axes of the hyper-paraboloid will not have a significant effect on the solution of the optimization problem of equation (3.9). The dependency of the second term in equation (3.10) is further reduced by the pre-scaling equation (3.7). Therefore, the total variability of the solution will be significantly reduced.

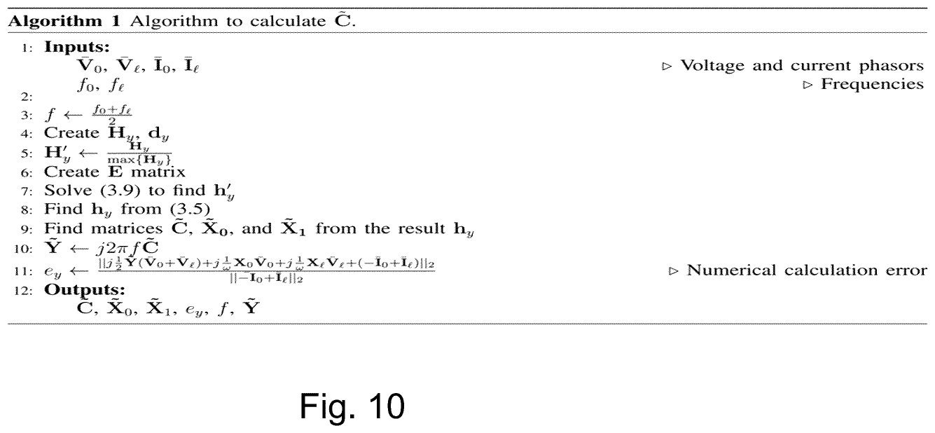

In the optimization problem of equation (3.9), the matrix H′_{y} is an ill-posed matrix but its numerical rank deficiency is only one. Without using the property of equation (2.4), the numerical rank deficiency of H′_{y} would be 5, which would result in an unstable optimization problem and inaccurate solutions. The value of ω can be chosen as a fixed number or the PMU measurement readout can be used to eliminate the effect of frequency variations. After finding h′_{y}, we can easily find h_{y} from equation (3.5). The process is summarized in Algorithm 1, which is shown in FIG. 10.

Suppose the solution to equation (3.9) is \tilde{C}₀. This solution is unique if the line is untransposed and/or unbalanced. Moreover, the optimization in equation (3.9) is essentially a least-squares optimization; therefore, the solution to equation (3.9) (\tilde{C}₀) will always have the correct structure given in the third and fourth properties in Section II.b. When the line is transposed and balanced or almost balanced, i.e., 1^{T}Σ_{V}≅0 (1^{T} is a row vector with all entries equal to one) and the solution will have the form of \tilde{C}₀+\tilde{C}′11^{T}, where \tilde{C}′ is an arbitrary number. By choosing \tilde{C}′ equal to the minus average of the off-diagonal entries of Co, the solution \tilde{C}₀+\tilde{C}′11^{T} becomes an almost diagonal matrix with the diagonal entries almost equal to each other. The values of the diagonal are called the phase capacitance of the line.

$${\tilde{C}}_{PS} = \frac{1}{3} ( {\tilde{C}}_{011} + {\tilde{C}}_{022} + {\tilde{C}}_{033} - {\tilde{C}}_{012} - {\tilde{C}}_{013} - {\tilde{C}}_{023} ) , \qquad ( 3.11 )$$

where \tilde{C}₀ᵢⱼ is the (i, j) entry of the matrix \tilde{C}₀. FIG. 10 illustrates Algorithim 1 to calculate \tilde{C}₀
b. Calculating Matrix \tilde{R} and \tilde{L}

To calculate the matrix \tilde{Z}, we can use the current flowing through the conductors of the line and the voltage drop across the line:

$$\tilde{Z} {\overline{I}}_{z} = {Δ}_{V} , {Δ}_{V} = {\overline{V}}_{0} - {\overline{V}}_{ℓ} , \qquad ( 3.12 )$$

where Ī_{z} is the current flowing through the conductors of the line. The current Ī_{z} can be calculated in three different ways:

$${\overline{I}}_{z} = {\overline{I}}_{0} - \frac{1}{2} \tilde{Y} {\overline{V}}_{0} - j \frac{1}{ω} {X}_{0} {\overline{V}}_{0} , \qquad ( 3.13 a )$$

$${\overline{I}}_{z} = {\overline{I}}_{ℓ} + \frac{1}{2} \tilde{Y} {\overline{V}}_{ℓ} + j \frac{1}{ω} {X}_{ℓ} {\overline{V}}_{ℓ} , \qquad ( 3.13 b )$$

$${\overline{I}}_{z} = \frac{1}{2} ( {\overline{I}}_{0} + {\overline{I}}_{ℓ} - \frac{1}{2} \tilde{Y} {Δ}_{V} + j \frac{1}{ω} {X}_{ℓ} {\overline{V}}_{ℓ} - j \frac{1}{ω} {X}_{0} {\overline{V}}_{0} ) . \qquad ( 3.13 c )$$

Any version of Ī_{z} in equation (3.13) can be used to calculate \tilde{Z}. In equation (3.13a), the current Ī₀, is more balanced because it is the current at the sending side of the line. In equation (3.13b), the current [symbol] is less balanced because it is at the receiving side of the line. In equation (3.13b), there is a mixture of both sides' currents that could represent the entire line. The matrix \tilde{Y} calculated in the previous step as explained in Section III.a.

By rearranging equation (3.12) and equation (3.13), we can write:

$${H}_{z} {h}_{z} = {d}_{z} , {H}_{z} ∈ , {h}_{z} ∈ , {d}_{z} ∈ , \qquad ( 3.14 )$$

where H_{z} comprises the current phasor Ī_{z}, d_{z} is a vector comprises the voltage phasor Δᵥ, and h_{z} is a vector comprises the unknown parameters \tilde{R} and \tilde{L}.

Then we can find the solution by solving the quadratic programming like equation (3.9):

$$\begin{matrix}{min}_{{h}_{z}} \\ s . t .\end{matrix} \begin{matrix}{h}_{z}^{T} {H}_{z}^{T} {H}_{z} {h}_{z} - 2 {d}_{z}^{T} {H}_{z} {h}_{z} \\ - {I}_{12} {h}_{z} \leq 0 , \\ {Fh}_{z} \leq 0.\end{matrix} \qquad ( 3.15 )$$

The inequality −I₁₂h_{z}≤0 enforces the nonnegative entries of \tilde{R} and \tilde{L} and Fh_{z}≤0 represent that the matrices \tilde{R} and \tilde{L} are diagonally dominant where F is defined as

$$F = [ \begin{matrix}{F}_{1} & 0 \\ 0 & {F}_{1}\end{matrix} ] , \qquad ( 3.16 )$$

$${F}_{1} = [ \begin{matrix}- 1 & 1 & 1 & 0 & 0 & 0 \\ 0 & 1 & 0 & - 1 & 1 & 0 \\ 0 & 0 & 1 & 0 & 1 & - 1\end{matrix} ] .$$

Solving the 1-norm or infinity-norm optimization problem can also be alternative ways:

$$\begin{matrix}{min}_{{h}_{z}} \\ s . t .\end{matrix} \begin{matrix}{‖ {H}_{z} {h}_{z} - {d}_{z} ‖}_{1 , ∞} \\ - {I}_{12} {h}_{z} \leq 0 \\ {Fh}_{z} \leq 0\end{matrix} . \qquad ( 3.17 )$$

Assume that the solution to equation (3.15) is \tilde{R}₀+jω\tilde{L}₀. When the line is transposed and balanced, there is no earth return current; therefore, the off diagonal of the matrix \tilde{R}₀ will be zero and the diagonal entries of the matrix \tilde{R}₀ will be almost equal. The constraints in equation (3.17) will force the solution to have these properties. These diagonal entries are phase resistance of the line that can be calculated as the average of the diagonal entries to account for noise and small variations:

$${\tilde{R}}_{PS} = \frac{1}{3} ( {\tilde{R}}_{011} + {\tilde{R}}_{022} + {\tilde{R}}_{033} ) , \qquad ( 3.18 )$$

where \tilde{R}₀ᵢⱼ is the (i, j) entry of the matrix \tilde{R}₀.

On the other hand, when the line is transposed and balanced, the matrix \tilde{L}₀=\tilde{L}+\tilde{L}′11^{T} (where \tilde{L} is the true inductance matrix of the line) will satisfy equation (3.15) because 1^{T}Ī_{z}≅0. The value of \tilde{L}′ is arbitrary. By forcing the entries of \tilde{L} to be positive, \tilde{L}′ becomes equal to the negative of the entries of \tilde{L} because the least squares optimization in equation (3.15) will converge to a minimum norm solution. Therefore, \tilde{L}₀ becomes an almost diagonal matrix with the diagonal entries almost equal to each other. The values of the diagonal entries are called the phase inductance of the line that can be calculated as the average of the diagonal entries to account for noise and small variations:

$${\tilde{L}}_{PS} = \frac{1}{3} ( {\tilde{L}}_{011} + {\tilde{L}}_{022} + {\tilde{L}}_{033} ) , \qquad ( 3.19 )$$

where \tilde{L}₀ᵢⱼ is the (i, j) entry of the matrix \tilde{L}₀.

Any significant deviation of \tilde{Z} from being a diagonal matrix can be interpreted as the introduction of an imbalance phenomenon in the transmission line such as icing and galloping.

To avoid the influence of the undesired fluctuations in the voltage and current phasors, we need to calculate \tilde{Z} matrix based on the power dissipated in the lines. This method is explained as follows:

We know that the apparent power dissipated in the transmission line cables is calculated as follows:

$$P = {{\overline{I}}_{z}}^{*} ⊙ ( \tilde{Z} {\overline{I}}_{z} ) = {{\overline{I}}_{z}}^{*} ⊙ {Δ}_{v} , P ∈ , \qquad ( 3.2 )$$

where ⊙ is the Hadamard product and Ī_{z} is defined in (3.13). We can rearrange equation (3.20) into

$${B}_{z} {h}_{z} = {g}_{z} , {B}_{z} = {[ {B}_{z 1}^{T} , {B}_{z 2}^{T} , ⋯ , {B}_{zN}^{T} ]}^{T} , {g}_{z} = {[ {g}_{z 1}^{T} , {g}_{z 2}^{T} , ⋯ , {g}_{zN}^{T} ]}^{T} . \qquad ( 3.21 )$$

Now by considering H_{z}=B_{z}, d_{z}=g_{z}, we can solve equation (3.15).

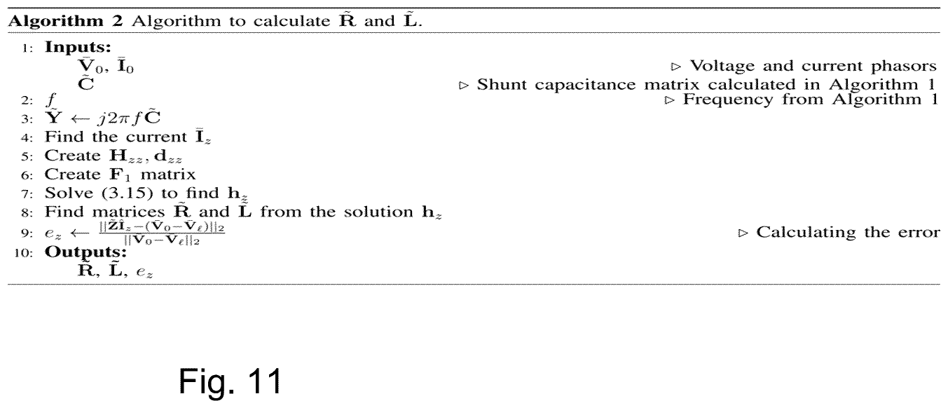

For the same reasons explained for equation (3.9), the solution of the optimization problem (3.15) always exists. The value of ω can be chosen as a fixed number or the PMU measurement readout can be used. Using pre-scaling on vector g_{z} might be a good idea in some circumstances. Algorithm 2 in FIG. 11, summarizes the process of calculating \tilde{R} and \tilde{L} in regard to the previously defined variables and equation 3.15.

c. Calculating the Geometry of the Transmission Time

According to the well-known equation (Paul, 2007):

$${\tilde{L}}_{0} {\tilde{C}}_{0} = {μ}_{0} {ε}_{0} {I}_{3} , \qquad ( 3.22 )$$

and considering that the line is balanced and transposed, \tilde{C}₀ and \tilde{L}₀ are diagonal matrices with the diagonal entries equal to the phase values per unit length (solutions of equations (3.9) and (3.15), respectively), and the fact that μ₀ε₀=c⁻² (c=299,702,547 m/s, is the speed of light in free space) we can write:

$${\tilde{L}}_{PS} {\tilde{C}}_{PS} = {ℓ}^{2} {c}^{- 2} , \qquad ( 3.23 )$$

where [symbol] is the true length of the line. Thus, we can find the true length of the line by:

$$ℓ = c \sqrt{{\tilde{L}}_{PS} {\tilde{C}}_{PS}} . \qquad ( 3.24 )$$

Now by knowing the true length of the line, we can find the ratio of the GMD (Geometric Mean Distance) and the GMR (Geometric Mean Radius) of the conductors. We know that the phase inductance can be shown as a function of D_{eq} and r, where D_{eq} is the GMD and r is the GMR of the conductors (Glover, Sarma, & Overbye, 2012) (see also equations (2.5) an (2.6)).

$${\tilde{L}}_{PS} = \frac{{μ}_{0}}{2 π} ln ( \frac{{D}_{eq}}{r} ) ℓ . \qquad ( 3.25 )$$

But the true length of the line is calculated in equation (3.24). Therefore, we will have:

$$ln ( \frac{{D}_{eq}}{r} ) = 2 π \sqrt{\frac{{ε}_{0} {\tilde{L}}_{PS}}{{μ}_{0} {\tilde{C}}_{PS}}} . \qquad ( 3.26 )$$

We can also find the per unit values of \tilde{L}_{PS} and \tilde{C}_{PS}:

$${L}_{PS} = \frac{{\tilde{L}}_{PS}}{ℓ} = \frac{1}{c} \sqrt{\frac{{\tilde{L}}_{PS}}{{\tilde{C}}_{PS}}} , \qquad ( 3.27 a )$$

$${C}_{PS} = \frac{{\tilde{C}}_{PS}}{ℓ} = \frac{1}{c} \sqrt{\frac{{\tilde{C}}_{PS}}{{\tilde{L}}_{PS}}} . \qquad ( 3.27 b )$$

d. Calculating Average Per Unit Resistance of the Line

The total resistance of the line (\tilde{R}_{PS}) is calculated in equation (3.18). The total

resistance of the line depends on the length and temperature of the line:

$${\tilde{R}}_{PS} = {\overline{R}}_{pu} ( {T}_{av} ) ℓ , \qquad ( 3.28 )$$

where R̅ₚᵤ(Tₐᵥ) is the average per unit resistance of the line at temperature Tₐᵥ and can be found using equations (3.43) and (3.39):

$${\overline{R}}_{pu} ( {T}_{av} ) = \frac{{\tilde{R}}_{PS}}{c \sqrt{{\tilde{L}}_{PS} {\tilde{C}}_{PS}}} . \qquad ( 3.29 )$$

e. Calculating Average Temperature of the Line

Using the relationship between the per unit resistance of the line and its

temperature (IEEE-738 Standard for Calculating the Current-Temperature Relationship of Bare Overhead Conductors, 2012):

$${\overline{R}}_{pu} ( {T}_{av} ) = \frac{{R}_{pu} ( {T}_{H} ) - {R}_{pu} ( {T}_{L} )}{{T}_{H} - {T}_{L}} ( {T}_{av} - {T}_{L} ) + {R}_{pu} ( {T}_{L} ) , \qquad ( 3.3 )$$

where Rₚᵤ(T_{H}), Rₚᵤ(T_{L}) are the per unit resistances of the line at temperature T_{H} and T_{L}, respectively. These two values are usually given in the cable manufacturer's data sheet. Now we can find the average temperature of the line using equation (3.30):

$${T}_{a v} = \frac{( {\overline{R}}_{p u} ( {T}_{a v} ) - {R}_{p u} ( {T}_{L} ) ) ( {T}_{H} - {T}_{L} )}{{R}_{p u} ( {T}_{H} ) - {R}_{p u} ( {T}_{L} )} + {T}_{L} . \qquad ( 3.31 )$$

If instead of knowing the per unit resistance of the cable at two temperatures T_{H} and T_{L}, the temperature coefficient of resistance (α) and the per unit resistance of the cable at one temperature are known, we can rewrite equation (3.30) as:

$${\overline{R}}_{p u} ( {T}_{a v} ) = {R}_{p u} ( {T}_{0} ) [ 1 + α ( {T}_{a v} - {T}_{0} ) ] , \qquad ( 3.32 )$$

where Rₚᵤ(T₀) is the per unit resistance of the cable at temperature T₀. Then the average temperature of the line can be found as:

$${T}_{a v} = \frac{{\overline{R}}_{p u} ( {T}_{a v} ) - {R}_{p u} ( {T}_{0} )}{α {R}_{p u} ( {T}_{0} )} + {T}_{0} . \qquad ( 3.33 )$$

### IV. Calculating Other Parameters

a. Calculating Characteristic Admittance Matrix

By using equations (2.10), (2.11) and the other formulas given in (Paul, 2007), we can derive:

$${Y}_{C} = \sqrt{{\tilde{Z}}_{0}^{- 1} {\tilde{Y}}_{0} ( {I}_{3} + \frac{1}{4} {\tilde{Z}}_{0} {\tilde{Y}}_{0} )} , {Z}_{C} = {Y}_{C}^{- 1} , \qquad ( 4.1 a )$$

where \tilde{Y}₀ and \tilde{Z}₀ are the matrices obtained in Section III.a and III.b. It is interesting to note that if

$$( {I}_{3} + \frac{1}{4} {\tilde{Z}}_{0} {\tilde{Y}}_{0} ) ≃ {I}_{3} , {Y}_{C} = \sqrt{{\tilde{Z}}_{0}^{- 1} {\tilde{Y}}_{0}}$$

will not depend on the length of the line [symbol] . In general, for balanced transmission lines, this is the case and Z_{C} does not depend on the length of the line because the entries of the shunt admittance matrix \tilde{Y}₀ are much smaller than the entries of the series impedance matrix \tilde{Z}₀; therefore, the entries of the term

$$\frac{1}{4} {\tilde{Z}}_{0} {\tilde{Y}}_{0}$$

are very small.

The problem with calculating Z_{C} is that when the line is balanced or near balanced, the matrix \tilde{Y}₀ is near singular and it makes Y_{C} near singular as well. To remedy this problem, we revise \tilde{Y}₀ to (2diag(\tilde{Y}₀)−diag(\tilde{Y}₀1)), where 1 is a column vector whose entries are all one, that converts Y into a diagonal matrix where the diagonals are the phase admittances capacitance matrices. Then we calculate Z_{C} and Y_{C} using equation (4.1a):

$${Y}_{C} = \sqrt{{\tilde{Z}}_{0}^{- 1} ( 2 diag ( {\tilde{Y}}_{0} ) - diag ( {\tilde{Y}}_{0} 1 ) ) ( {I}_{3} + \frac{1}{4} {\tilde{Z}}_{0} ( 2 diag ( {\tilde{Y}}_{0} ) - diag ( {\tilde{Y}}_{0} ) ) ) ,} \qquad ( 4.1 b )$$

b. Calculating the Surge Impedance Loading (SIL)

The SIL is the power delivered by a lossless line to a resistive load equal to characteristic impedance (Glover, Sarma, & Overbye, 2012). The SIL for a single-phase line has been calculated as:

$$SIL = \frac{{V}_{rated}^{2}}{{Z}_{C}} , \qquad ( 4.2 )$$

where V_{rated} is the rated voltage of the line and Z_{c} is the characteristic impedance of the line.

To find the SIL for a three-phase line, we need to assume that the line is lossless. This means that a characteristic impedance matrix Z_{C} is a real-valued matrix. By taking the real part of Z_{C} we will have

$${{Y}^{⌣}}_{C} = e \{ {Y}_{C} \} = e \{ {Z}_{C}^{- 1} \} , \qquad ( 4.3 )$$

Then, by using (2.26) and Ī [symbol] =Y_{C}V̅ [symbol] , we will have:

$${\overline{V}}_{ℓ} = [ cosh ( \sqrt{Z Y} ℓ ) - sinh ( \sqrt{Z Y} ℓ ) ] {\overline{V}}_{0} = {e}^{\sqrt{Z Y} ℓ} {\overline{V}}_{0} , \qquad ( 4.4 )$$

$${\overline{I}}_{ℓ} = {\check{Y}}_{c} [ cosh ( \sqrt{Z Y} ℓ ) - sinh ( \sqrt{Z Y} ℓ ) ] {\overline{V}}_{0} = {\check{Y}}_{c} {e}^{\sqrt{Z Y} ℓ} {\overline{V}}_{0} .$$

The power delivered at z= [symbol] (the SIL) can be calculated (using the fact that Y̆_{C} is a real-valued matrix):

$$SIL = {\overline{I}}_{ℓ}^{H} {\overline{V}}_{ℓ} = {{\overline{V}}_{0}^{H} ( {e}^{\sqrt{Z Y} ℓ} )}^{H} {{Y}^{⌣}}_{C} ( {e}^{\sqrt{Z Y} ℓ} ) {\overline{V}}_{0} , \qquad ( 4.5 )$$

where H is conjugate transposed operator (Hermitian operator). By using the identities given in (Paul, 2007), we can derive:

$$SIL = {\overline{V}}_{0}^{H} {e}^{- j \sqrt{{\tilde{Y}}_{0 i} {\tilde{Z}}_{0 i}}} {{Y}^{⌣}}_{C} {{Z}^{⌣}}_{C} {e}^{j \sqrt{{\tilde{Y}}_{0 i} {\tilde{Z}}_{0 i}}} {{Y}^{⌣}}_{C} {\overline{V}}_{0} = {\overline{V}}_{0}^{H} {{Y}^{⌣}}_{C} {\overline{V}}_{0} , \qquad ( 4.6 )$$

where \tilde{Y}₀ᵢ and \tilde{Z}₀ᵢ are the imaginary parts of \tilde{Y}₀ and \tilde{Z}₀, respectively. If we consider that |V̅₀| is the rated voltage of the line, one can see that equation (4.6) is easily reduced to the single-phase SIL equation (4.2).

To find the average SIL in each window of N samples, we can write V̅₀ in terms of its real part and imaginary parts V̅₀=V̅₀ᵣ+jV̅₀ᵢ. By plugging in the equation in equation (4.5), and some simple algebraic equations we will have:

$$SIL = {\overline{V}}_{0 r}^{T} {{Y}^{⌣}}_{C} {\overline{V}}_{0 r} + {\overline{V}}_{0 i}^{T} {{Y}^{⌣}}_{C} {\overline{V}}_{0 i} \qquad ( 4.7 )$$

It should be noted that the SIL is calculated for every sample of the measured voltages and current phasors (outputs of the PMUs) over N sample interval indicated in equation (3.1). Then the average will be calculated to find the SIL of the N-sample interval.

c. Calculating the Line Stability Limit (Loadability)

A transmission line cannot deliver unlimited power. The maximum active power that a transmission line can deliver is called the stability limit or loadability and is determined by its impedance and admittance matrices \tilde{Y}₀ and \tilde{Z}₀ and it is usually normalized by the SIL The voltage phase difference between the sending and receiving ends of the line (sides 0 and [symbol] in FIG. 7, respectively) determines the line loadability. By using equation (2.15) we can write:

$${\overline{V}}_{0} = ( {I}_{3} + \frac{1}{2} {\tilde{Z}}_{0} {\tilde{Y}}_{0} ) {\overline{V}}_{ℓ} + {\tilde{Z}}_{0} {\overline{I}}_{ℓ} . \qquad ( 4.8 )$$

Now by using equation (4.8), we can first find Ī [symbol] and then find the apparent power ( [symbol] ) delivered at the receiving side (z= [symbol] ) of the transmission line:

$${S}_{ℓ} = {\overline{I}}_{ℓ}^{H} {\overline{V}}_{ℓ} = {{\overline{V}}_{0}^{H} ( {\tilde{Z}}_{0}^{*} )}^{- 1} {\overline{V}}_{ℓ} - {\overline{V}}_{ℓ}^{H} [ {( {\tilde{Z}}_{0}^{*} )}^{- 1} + \frac{1}{2} {\tilde{Y}}_{0}^{*} ] {\overline{V}}_{ℓ} . \qquad ( 4.9 )$$

The second term of equation (4.9) is almost constant because [symbol] , \tilde{Y}₀ and \tilde{Z}₀ are almost constant at each moment of time. But the first term can significantly change because of the phase difference between \tilde{V}₀ and [symbol] . Therefore, [symbol] will be maximized if the first term of equation (4.9) is maximized.

For a balanced transmission line calculated in Section III.b, the series impedance matrix \tilde{Z}₀ is diagonal. This means that the series mutual impedances have no contribution to the power loss of the line, so we can comfortably assume:

$${( {\tilde{Z}}_{0}^{*} )}^{- 1} = {\tilde{Ψ}}^{*} ≃ [ \begin{matrix}\vert {ψ}_{aa} \vert {e}^{- j {β}_{aa}} & 0 & 0 \\ 0 & \vert {ψ}_{bb} \vert {e}^{- j {β}_{bb}} & 0 \\ 0 & 0 & \vert {ψ}_{cc} \vert {e}^{- j {β}_{cc}}\end{matrix} ] , \qquad ( 4.1 )$$

Then, the first term of (4.9) will be:

$${\overline{V}}_{0}^{H} {\tilde{Ψ}}^{*} {\overline{V}}_{ℓ} = \vert {\overline{v}}_{ℓ a} \vert \vert {\overline{v}}_{0 a} \vert \vert {ψ}_{aa} \vert {e}^{j ( {δ}_{aa} - {β}_{aa} )} + \vert {\overline{v}}_{ℓ b} \vert \vert {\overline{v}}_{0 b} \vert \vert {ψ}_{bb} \vert {e}^{j ( {δ}_{bb} - {β}_{bb} )} + \vert {\overline{v}}_{ℓ c} \vert \vert {\overline{v}}_{0 c} \vert \vert {ψ}_{cc} \vert {e}^{j ( {δ}_{cc} - {β}_{cc} )} , \\ {δ}_{pp} = {α}_{ℓ p} - {α}_{0 p} , p ∈ \{ a , b , c \} , \qquad ( 4.11 )$$

where δₚₚ is the angular displacement of the voltage of phase p. Therefore, the active power delivered at the receiving side of the transmission line [symbol] can be found by substituting equation (4.11) into equation (4.9)

$${P}_{ℓ} = \vert {\overline{v}}_{ℓ a} \vert \vert {\overline{v}}_{0 a} \vert \vert {ψ}_{aa} \vert cos ( {δ}_{aa} - {β}_{aa} ) + \vert {\overline{v}}_{ℓ b} \vert \vert {\overline{v}}_{0 b} \vert \vert {ψ}_{bb} \vert cos ( {δ}_{bb} - {β}_{bb} ) + \vert {\overline{v}}_{ℓ c} \vert \vert {\overline{v}}_{0 c} \vert \vert {ψ}_{c c} \vert cos ( {δ}_{cc} - {β}_{cc} ) - e \{ {\overline{V}}_{ℓ}^{H} [ {( {\tilde{Z}}_{0}^{*} )}^{- 1} + \frac{1}{2} {\tilde{Y}}_{0}^{*} ] {\overline{V}}_{ℓ} \} . \qquad ( 4.12 )$$

The maximum of (4.1) happens when:

$${δ}_{pp} = {β}_{pp} , p ∈ \{ a , b , c \} , \qquad ( 4.13 )$$

Therefore, the line loadability can be calculated by substituting equation (4.13) into equation (4.12):

$${P}_{m ax} = \vert {\overline{v}}_{ℓ a} \vert \vert {\overline{v}}_{0 a} \vert \vert {ψ}_{aa} \vert + \vert {\overline{v}}_{ℓ b} \vert \vert {\overline{v}}_{0 b} \vert \vert {ψ}_{bb} \vert + \vert {\overline{v}}_{ℓ c} \vert \vert {\overline{v}}_{0 c} \vert \vert {ψ}_{cc} \vert - e \{ {\overline{V}}_{ℓ}^{H} [ {( {\tilde{Z}}_{0}^{*} )}^{- 1} + \frac{1}{2} {\tilde{Y}}_{0}^{*} ] {\overline{V}}_{ℓ} \} . \qquad ( 4.14 )$$

We can achieve the loadability of a transmission line by adjusting the angular displacement of the phases. The result in equation (4.12) is also consistent with the single-phase stability limit derived in (Glover, Sarma, & Overbye, 2012):

$${P}_{Rm ax} = \frac{{V}_{0} {V}_{ℓ}}{\tilde{Z}} - \frac{{AV}_{ℓ}^{2}}{\tilde{Z}} cos ( {θ}_{Z} - {θ}_{A} ) , \qquad ( 4.15 )$$

where \tilde{Z} is the magnitude of the impedance of the line, A is the magnitude of the upper left entry of the ABCD matrix (CPM), θ_{Z} is the phase of the impedance of the line, θ_{A} is the phase of the upper left entry of the ABCD matrix, and V₀ and [symbol] are the line-to-line magnitude of voltages at the sending and receiving ends of the line, respectively.

It is customary to normalize the line loadability with respect to its SIL. The result would be per-unit SIL line loadability:

$${P}_{PUSIL} = \frac{{cP}_{m ax}}{{\overline{V}}_{0}^{H} {{Y}^{⌣}}_{C} {\overline{V}}_{0}} . \qquad ( 4.16 )$$

where c is the coefficient that sets the stability margin of the line. It has been proposed that the stability margin to be set between 30% and 35% of the theoretical loadability upper bound (Gutman, Marchenko, & Dunlop, 1979). Therefore, the coefficient c should be set between 0.7 and 0.75. The P_{PUSIL} provides the celebrated St. Clare's curve (Gutman, Marchenko, & Dunlop, 1979) for lines longer than 80 km. For short lines (shorter than 80 km), the loadability is determined by the thermal rating of the line and usually is capped at three times the SIL.

The assumption of equation (4.13) is not realistic because the angular displacement δₚₚ is set by the system operator. Usually, the angular displacement is set to 30° or 35°. Let this value be δ₀, then the loadability can be found using equation (4.12):

$${P}_{m ax} = \vert {\overline{v}}_{ℓ a} \vert \vert {\overline{v}}_{0 a} \vert \vert {ψ}_{aa} \vert cos ( {δ}_{0} - {β}_{aa} ) + \vert {\overline{v}}_{ℓ b} \vert \vert {\overline{v}}_{0 b} \vert \vert {ψ}_{bb} \vert cos ( {δ}_{0} - {β}_{bb} ) + \vert {\overline{v}}_{ℓ c} \vert \vert {\overline{v}}_{0 c} \vert \vert {ψ}_{cc} \vert cos ( {δ}_{0} - {β}_{cc} ) - e \{ {\overline{V}}_{ℓ}^{H} [ {( {\tilde{Z}}_{0}^{*} )}^{- 1} + \frac{1}{2} {\tilde{Y}}_{0}^{*} ] {\overline{V}}_{ℓ} \} . \qquad ( 4.17 )$$

Using equation (4.17), we will not need to set the stability margin c.

We also consider the maximum allowed voltage drop across the line to be 5%. Therefore, the loadability for balanced and transposed lines can be shown as:

$${P}_{m ax} = 0.95 {\vert {\overline{v}}_{0 a} \vert}^{2} \vert {ψ}_{aa} \vert cos ( {δ}_{0} - {β}_{aa} ) + 0.95 {\vert {\overline{v}}_{0 b} \vert}^{2} \vert {ψ}_{bb} \vert cos ( {δ}_{0} - {β}_{bb} ) + 0.95 {\vert {\overline{v}}_{0 c} \vert}^{2} \vert {ψ}_{cc} \vert cos ( {δ}_{0} - {β}_{cc} ) - 0 \text{.9025} e \{ {\overline{V}}_{0}^{H} [ {( {\tilde{Z}}_{0}^{*} )}^{- 1} + \frac{1}{2} {\tilde{Y}}_{0}^{*} ] {\overline{V}}_{0} \} . \qquad ( 4.18 )$$

Similar to calculating the SIL, Pₘₐₓ will also be the average of equation (4.18) calculated for each sample of the N sample interval.

d. Calculating the Theoretical Ampacity of the Line

Another important parameter in transmission lines is their ampacity, which is defined as the maximum current that they can carry (also known as current carrying capacity). We can calculate the ampacity by first calculating the maximum current delivered at the receiving end of the transmission line. First, we define:

$${\overline{I}}_{ℓ} = {[ {\overline{ι}}_{ℓ a} , {\overline{ι}}_{ℓ b} , {\overline{ι}}_{ℓ c} ]}^{T} = {[ \vert {\overline{ι}}_{ℓ a} \vert {e}^{j {ϵ}_{ℓ a}} , \vert {\overline{ι}}_{ℓ b} \vert {e}^{j {ϵ}_{ℓ b}} , \vert {\overline{ι}}_{l c} \vert {e}^{j {ϵ}_{ℓ c}} ]}^{T} . \qquad ( 4.19 )$$

Then, we can find the apparent power at the receiving end:

$${S}_{ℓ} = {\overline{I}}_{ℓ}^{H} {\overline{V}}_{ℓ} = \vert {\overline{ι}}_{ℓ a} \vert \vert {\overline{v}}_{ℓ a} \vert {e}^{j ( {α}_{ℓ a} - {ϵ}_{ℓ a} )} + \vert {\overline{ι}}_{ℓ b} \vert \vert {\overline{v}}_{ℓ b} \vert {e}^{j ( {α}_{ℓ b} - {ϵ}_{ℓ b} )} + \vert {\overline{ι}}_{ℓ c} \vert \vert {\overline{v}}_{ℓ c} \vert {e}^{j ( {α}_{ℓ c} - {ϵ}_{ℓ c} )} . \qquad ( 4.2 )$$

Obviously, the active power delivered at the receiving end of the line is maximum when the power factor of each phase is one, i.e., the current and voltages are in-phase, or the load is pure resistive. By assuming the current magnitudes in all three phases to be the same (because the line is assumed to be balanced), the maximum active power flow will be:

$${P}_{m ax} = \vert {\overline{ι}}_{ℓ m} \vert ( \vert {\overline{v}}_{ℓ a} \vert + \vert {\overline{v}}_{ℓ b} \vert + \vert {\overline{v}}_{ℓ c} \vert ) , \qquad ( 4.21 )$$

where | [symbol] | is the maximum current magnitude in each phase at the receiving end of the line, which can be found as:

$$\vert {\overline{ι}}_{ℓ m} \vert = \frac{{P}_{m ax}}{\vert {\overline{v}}_{ℓ a} \vert + \vert {\overline{v}}_{ℓ b} \vert + \vert {\overline{v}}_{ℓ c} \vert} , \qquad ( 4.22 )$$

where Pₘₐₓ is the line loadability derived in equation (4.18), and

$${\overline{I}}_{ℓ m} = {[ {\overline{ι}}_{ℓ am} , {\overline{ι}}_{ℓ bm} , {\overline{ι}}_{ℓ c m} ]}^{T} = {[ \vert {\overline{ι}}_{ℓ m} \vert {e}^{j {α}_{ℓ a}} , \vert {\overline{ι}}_{ℓ m} \vert {e}^{j {α}_{ℓ b}} , \vert {\overline{ι}}_{ℓ m} \vert {e}^{j {α}_{ℓ c}} ]}^{T} . \qquad ( 4.23 )$$

On the other hand, it was shown that the maximum power is calculated at the worst-case scenario when the phase displacement angle is at maximum δ₀. Therefore, the maximum current at the receiving end will be:

$${\overline{I}}_{ℓ m} = {[ {\overline{ι}}_{ℓ am} , {\overline{ι}}_{ℓ bm} , {\overline{ι}}_{ℓ c m} ]}^{T} = {[ \vert {\overline{ι}}_{ℓ m} \vert {e}^{j ( {δ}_{0} - {β}_{aa} )} , \vert {\overline{ι}}_{ℓ m} \vert {e}^{j ( {δ}_{0} - {β}_{bb} )} , \vert {\overline{ι}}_{ℓ m} \vert {e}^{j ( {δ}_{0} - {β}_{cc} )} ]}^{T} . \qquad ( 4.2 4 )$$

Now, we can find the maximum current flowing through the lines (Ī_{Zm}) using the second equation of equation (2.13b) after removing the effect of shunt reactors:

$${\overline{I}}_{Z m} = {\overline{I}}_{ℓ m} + \frac{1}{2} {\tilde{Y}}_{0} {\overline{V}}_{ℓ} . \qquad ( 4.25 )$$

Similar to calculating the SIL, Ī_{Zm} will also be the average of equation (4.23) calculated over the N sample interval and, the ampacity would be the minimum of the calculated maximum currents:

$${I}_{Zmax} = min \{ \vert {\overline{ι}}_{Zma} \vert , \vert {\overline{ι}}_{Zmb} \vert , \vert {\overline{ι}}_{Zmc} \vert \} . \qquad ( 4.26 )$$

### V. Calculating Spans' Temperatures (LineID-Spans)

In previous sections, we assumed that the transmission line is uniform, i.e., the per-unit values of the parameters are the same throughout the transmission line. In reality, this is not the case because temperature varies at different spans of a transmission line. If spans of a transmission line have different temperatures, the ampacity of the line is determined by the span with the highest temperature. Moreover, different temperatures at different spans of the line also causes more sag that can lead to clearance violations. In existing DLR technologies, the most affected spans are identified and termed as the critical spans of the transmission line.

To consider a nonuniform transmission line, we need to make the following assumptions:

Assumption 1. The transmission line is balanced and transposed. This assumption allows us to use phase values, of equations (3.11), (3.18) and (3.19).

Assumption 2. The changes of the values in the three conductors are identical. We assume that the environmental parameters such as temperature affect the phase conductors, equally.

Assumption 3. The length of the transmission line is much shorter than the wavelength in short time intervals. This assumption allows us to approximate \tilde{Z} as Z [symbol] and \tilde{Y} as Y [symbol] . These approximations do not hold if the transmission line is long, but we proceed with them, nonetheless.

Referring back to FIGS. 3A, 3B, and 3C, to find the variation of the temperature along the line, we divide the line into M spans and we assume that the average per unit resistance of each span is constant. In Section III.d, the average per unit resistance of the line at time t was calculated to be R̅ₚᵤ(t). Assume that at span m the per unit resistance at time t is Rₚᵤ(m, Tₘ(t)), where Tₘ(t) is the average temperature and [symbol] ₘ(t) is the length of the m^{th} span at time t. Then we can easily see

$${\overline{R}}_{p u} ( t ) = \frac{1}{ℓ} {\sum }_{m = ℓ}^{M} {ℓ}_{m} ( t ) {R}_{pu} ( m , {T}_{m} ( t ) ) . \qquad ( 5.1 )$$

Using (3.45) and (5.1), we can write:

$${R}_{pu} ( m , {T}_{m} ( t ) ) = ξ ( {T}_{m} ( t ) - {T}_{L} ) + {R}_{pu} ( {T}_{L} ) , ξ = \frac{{R}_{pu} ( {T}_{H} ) - {R}_{pu} ( {T}_{L} )}{{T}_{H} - {T}_{L}} , \qquad ( 5.2 )$$

where T_{L} and T_{H} are the temperatures at which the conductors were tested in the lab and are available in conductor's manufacturer's data sheet.

By substituting Rₚᵤ(m, Tₘ(t)) in (5.1) with (5.2), we will have:

$${\overline{R}}_{pu} ( t ) = \frac{ξ}{ℓ} {\sum }_{m = 1}^{M} [ {ℓ}_{m} ( t ) {T}_{m} ( t ) ] - ξ {T}_{L} + {R}_{pu} ( {T}_{L} ) . \qquad ( 5.3 )$$

By defining and using the vectors T(t)=[T₁(t)T₂(t) . . . T_{M}(t)]^{T}, [symbol] (t)=[ [symbol] ₁(t) [symbol] ₂(t) . . . [symbol] _{M}(t)]^{T} in equation (5.3), we will have:

$${ℓ}^{T} ( t ) T ( t ) = \frac{l}{ξ} {\overline{R}}_{p u} ( t ) - \frac{ℓ}{ξ} {R}_{p u} ( {T}_{L} ) + ℓ {T}_{L} . \qquad ( 5.4 a )$$

The [symbol] ₘ(t) can be calculated by the catenary-length formula:

$${ℓ}_{m} ( t ) = \frac{2 w}{H ( t )} sinh ( \frac{w {ℓ}_{h m}}{2 H ( t )} ) , \qquad ( 5.4 b )$$

where [symbol] ₘ is the length of the conductor of the m^{th} span, w is the weight per-unit length of the conductor, H(t) is the horizontal tension of the conductor and [symbol] ₕₘ is the horizontal distance between the towers. The length of the line and consequently its spans do not change much with time. Therefore, we can assume that [symbol] (t)= [symbol] .

According to IEEE 738 Standard, the temperature of the m^{th} span of the line conductors \hat{T}ₘ(t) at a given time t can be found by iteratively solving the following equation:

$${q}_{c} ( m , {\hat{T}}_{m} ( t ) ) + {q}_{r} ( m , {\hat{T}}_{m} ( t ) ) = {q}_{s} ( m ) + {I}^{2} {R}_{pu} ( m , {\hat{T}}_{m} ( t ) ) , \qquad ( 5.5 )$$

where q_{c}(m, \hat{T}m(t)), qᵣ(m, \hat{T}ₘ(t)), qₛ(m), \hat{T}ₘ(t), and I are the convective heat loss, radiative heat loss, solar heat gain, estimated temperature of the conductor at the m^{th} span at time t, and the current magnitude of each phase of the conductor. The magnitude current I is directly measured by the PMU (for a conservative assessment, we consider the magnitude current at the sending side of the transmission line).

We can use equations for the heat losses and gains in (5.5) and solve the equation (5.5) \hat{T}ₘ(t). This should be done for all spans (m=1 . . . M) to find the vector \hat{T}(t)=[\hat{T}₁(t) \hat{T}₂(t) . . . \hat{T}_{M}(t)]^{T}. Due to simplifications, inherent inaccuracies in the weather data and uncertainties in the equations themselves, the vector \hat{T}(t) will not be the true temperature vector, i.e., \hat{T}(t)≠T(t).

To find the true temperatures T(t), we assume that they are functions of the estimated temperatures \hat{T}(t). We can approximate these functions using Taylor's series:

$${T}_{m} ( t ) = {δ}_{0 m} + {δ}_{I m} {\hat{T}}_{m} ( t ) + {δ}_{2 m} {\hat{T}}_{m}^{2} ( t ) + … + {δ}_{d m} {\hat{T}}_{m}^{d} ( t ) , m = 1 … M . \qquad ( 5.6 )$$

The order d can be arbitrarily chosen to be of any value. By rearranging equation (5.6), we can show it in matrix form:

$$\hat{T} δ = \frac{ℓ}{ξ} {\overline{R}}_{p u} - \frac{ℓ}{ξ} {R}_{p u} ( {T}_{L} ) + ℓ {T}_{L} , \qquad ( 5.7 )$$

where \hat{T} is a B×(d+1) M matrix (where B is the number of time instances where the average per unit resistance of the line are calculated) containing the inaccurate temperature weighted by the length of the conductor of all span calculated by using equation (5.5), δ is a vector containing all coefficients in equation (5.6) and R̅ₚᵤ is a vector containing the average per unit resistance of the line at all B time instances.

For B number of average per unit resistances calculated by equation (3.29) over time, we need to calculate (d+1) coefficients of the d^{th} order polynomial for M number of spans. This means that we will need (d+1)M number of average resistances over time. Each value of the average resistance has been calculated by N time samples. Therefore, to calculate the true temperature of each span, we need at least (d+1)MN time samples. This indicates that to find the temperature of the spans, we need more information from the data, hence a greater number of samples.

Moreover, we need to make sure that the temperature at the chosen M spans are significantly different. Otherwise, \hat{T} in equation (5.7) will be ill-posed and solving equation (5.7) will be difficult. In case the condition number of \hat{T} is high, we can combine spans with close temperatures and reduce the number of spans M. It should be noted that these spans should not necessarily be adjacent. We can solve equation (5.7) using any method that minimizes

$$‖ \hat{T} δ - \frac{ℓ}{ξ} {\overline{R}}_{p u} - \frac{ℓ}{ξ} {R}_{p u} ( {T}_{L} ) + ℓ {T}_{L} ‖ .$$

When the norm is Euclidean, the approximate solution of (5.7) can be found:

$${δ}_{s} = \frac{ℓ}{ξ} {\hat{T}}^{†} {\overline{R}}_{p u} - ( \frac{ℓ}{ξ} {R}_{p u} ( {T}_{L} ) - ℓ {T}_{L} ) {\hat{T}}^{†} , \qquad ( 5.8 )$$

where \hat{T}^{†} is the Moore-Penrose pseudo-inverse of \hat{T}. Now plugging the solution δₛ into equation (5.6), we can find the true temperatures of the spans.

Note-1: The minimum number of spans and their locations are determined by ensuring that \hat{T} is not ill-posed, i.e., its condition number is small enough so that equation (5.7) has a stable solution.

Note-2: The estimation error of \hat{T}ₘ(t) is not important because the time variations of the average conductor's resistance R̅ₚᵤ(t) that have been calculated from the PMU data in Section III.b are employed to compensate for this error. This scheme allows us to assign empirically calculated temperatures to \hat{T}ₘ(t) and avoid iteratively solving equation (5.5) all together.

Note-3: The temperature of the spans can also be directly measured by installing temperature sensors on the conductors. These measurements can replace \hat{T}ₘ(t) in the corresponding spans. This way, we can have a more accurate calculations for the temperature of the spans where the method based on weather information is not applicable for any reason.

Note-4: In equation (5.6), Tₘ(t) is a linear combination of powers of \hat{T}ₘ(t). This relationship can be extended to a linear combination of d+1 arbitrary functions of \hat{T}ₘ(t) such as:

$${T}_{m} ( t ) = {δ}_{0 m} + {δ}_{1 m} {f}_{1} ( {\hat{T}}_{m} ( t ) ) + {δ}_{2 m} {f}_{2} ( {\hat{T}}_{m} ( t ) ) + {δ}_{3 m} {f}_{3} ( {\hat{T}}_{m} ( t ) ) + … + {δ}_{d m} {f}_{d} ( {\hat{T}}_{m} ( t ) ) , m = 1 … M . \qquad ( 5.9 )$$

where ƒ₁(⋅), ƒ₂(⋅), ƒ₃(⋅), ƒ₄(⋅), . . . are arbitrary functions that can be identified from data.

The block diagram of LineID was previously shown in FIGS. 1, 2, 3A, and 3B. The overall LineID black diagram was previously shown in FIG. 1B. The details of how LineID operates within the computer system within the software runs on a computer system and interacts with the other components of the system are shown in FIGS. 2-3A.

### VI. Alternative Implementation

By assuming the matrices \tilde{G}, \tilde{C} and \tilde{L} as diagonal matrices, 9 unknowns (the off-diagonal entries of these matrices) will be zero and solving equations (3.16) and (3.35) will be much easier, i.e., there will be no ill-posed equations and there will no need for sophisticated algorithms such as Algorithm-1 and Algorithm-2. The other results (such as characteristic impedance matrix, loadability, ampacity, etc.) will also be easily found. Nevertheless, the accuracy of the method will deteriorate significantly, and the results will have huge errors because only positive sequence of the voltages and currents are used and slight imbalances between the phases are ignored. Moreover, these methods cannot detect phenomena such as galloping and icing.

### VII. Additional Observations Regarding Modeling For Well-Poised Solutions

The solutions to equations (3.4) and (3.14) represent the parameters of the transmission line (the \tilde{Z} and \tilde{Y} matrices). Both equations can be expressed in the form of a linear equation:

$$Ax = b ,$$

where x is a vector containing the entries of the \tilde{Z} and \tilde{Y} matrices. The problem is that the matrix A is highly ill-posed, meaning it has several singular values close to zero. To solve the equation, one should use the Moore Penrose pseudo-inverse of A, denoted A^{†}, as follows:

$$x = {A}^{†} b ,$$

Because some of the singular values of A are close to zero (indicating that A is highly ill-posed), the Moore Penrose pseudo-inverse of A has large entries, which amplifies small variations in b caused by noise and other measurement uncertainties. As a result, the solution x exhibits high variability and is essentially useless. This phenomenon has long been known, and many have attempted to resolve it either by simplifying the problem—e.g., by assuming that the line is balanced or by considering only the positive sequence of voltages and currents—or by applying established mathematical techniques, such as Tikhonov regularization.

In general, the literature formulates the linear equation Ax=b as a least-squares optimization problem, minimizing ∥Ax−b∥ to account for noise. However, the conventional approach is inadequate for a useful dynamic line rating engine.

In this disclosure, the following steps have been taken to remedy the problems and reduce variability:

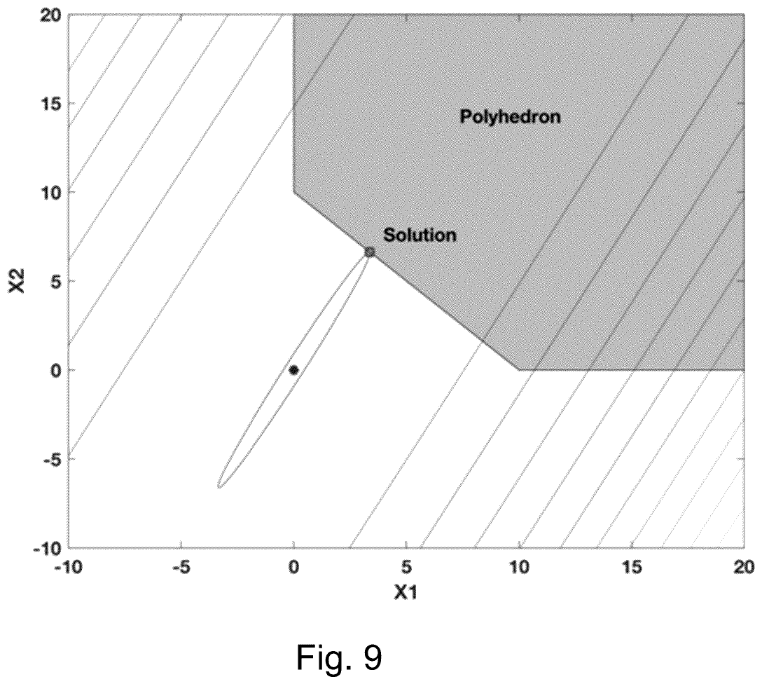

First, the physical characteristics of the transmission line are used to limit the search area when the optimization problem is solved. These characteristics include the sign of the entries of \tilde{Z} and \tilde{Y} matrices as well as the properties of the matrices such as the \tilde{Y} matrix is hyper-dominant, and the \tilde{Z} matrix has all positive entries, and it is diagonally dominant. Limiting the search area will reduce the variability of the solution by preventing it from leaving the search area. Second, if the objective function ∥Ax−b∥ is expanded to x^{T}A^{T}Ax−2b^{T}Ax+b^{T}b, the optimization can be solved by quadratic programing with linear constraints. The term b^{T}b is a scalar that does not have any effect in the optimization because it is not a function of x. The objective function x^{T}A^{T}Ax−2b^{T}Ax+b^{T}b represents a hyper-paraboloid whose vertex is at A^{†}b. We already know that A^{†}b has a very high variability. So, the intersection of the hyper-paraboloid and the search area, which is the polyhedron created by the constraints, highly depends on the measurement noise and uncertainty of the vertex A^{†}b. If we remove the term b^{T}b and solve the optimization problem as a quadratic problem, the center of the hyper-paraboloid x^{T}A^{T}Ax−2b^{T}Ax will always be at the origin. So, the variability in b will be manifested only in the size and direction of the hyper-paraboloid, which will have significantly less effect on the solution (the point where the hyper-paraboloid touches the polyhedron). See FIG. 9 in the disclosure.

It has also been shown that the solution of the optimization problem is not unique when the line is balanced. In this case, we choose a certain solution that provides us with the positive sequence of \tilde{Z} and \tilde{Y} matrices. These particular solutions illustrate the resistance, shunt capacitance, and self-inductance of the line that can be used to calculate the length of the line, the overall temperature of the line, the GMD/GMR ratio of the conductors, surge impedance loading, ampacity, characteristic impedance, and other parameters of the line that are explained in the disclosure in detail.

When the line becomes unbalanced due to naturally occurring phenomena such as galloping or icing, the solution to the optimization problem becomes unique and it illustrates the existence of an unusual situation. In these situations, the values of the calculated \tilde{Z} and \tilde{Y} matrices can be used to determine the parameters. For example, the condition number of \tilde{Z} and \tilde{Y} matrices can indicate that an event has occurred that made the line unbalanced.

In one implementation, the optimization problem (quadratic problem) is solved by using a QSQP package that employes Alternating Direction Method of Multipliers (ADMM) algorithm. In the algorithm, the tolerance of the solution can be adjusted to have faster or more accurate solutions.

In one implementation, the LineID-Spans algorithm (previously described) first calculates the temperature of all spans along the line using an approximate heat balance equation based on IEEE 738. The equation's components incorporate weather data and conductor parameters to provide a rough estimate of each span's temperature. Because these calculations do not need to be highly accurate, extremely precise weather data is not required. The real part of the \tilde{Z} matrix—the phase resistance given in equation (3.18)—and the length of the line, calculated by equation (3.24), are used to find the average per unit resistance of the line. This average per unit resistance of the line is equal to the weighted sum of the per unit resistance of all spans. The weights are the length of the conductor at each span that can be calculated by the catenary-length formula (7.4b).

Moreover, we can assume that the true temperatures of the spans at a given time are a nonlinear function of their approximate temperatures calculated by using IEEE 738 formulas. Using Taylor series, we can assume that this nonlinear function is a d^{th} order polynomial. This concept can be generalized so that the true temperatures of the spans at a given time is a linear combination of d arbitrary functions of their approximate temperatures and a constant as shown in equation (7.16).

For B number of average resistances calculated by the LineID engine over time, we need to calculate (d+1) coefficients of the d^{th} order polynomial for M number of spans. This means that we will need at least (d+1)M number of average resistances over time, i.e. B≥(d+1)M. Each value of the average resistance has been calculated by N time samples. Therefore, to calculate the true temperature of each span, we need at least (d+1)MN time samples. This indicates that to find the temperature of the spans, we need more information from the data, hence a greater number of samples.

A core concept of LineID-Spans algorithm lies in the fact that the sum of the resistances of all spans of the line is the same as the average resistance of the entire line calculated from the optimization problems at each instance of time. However, these sums are not necessarily equal to the average resistances due to the inaccuracies in calculating the resistances of the spans from weather data. To make these equations hold, we assume that there is a relationship between the temperatures calculated from weather data and the true temperatures of the spans, which are unknown. Then we use several instances of the average resistance of the line to find these relationships that are assumed to be linear combinations of powers of the inaccurate temperatures (polynomial approximation) or linear combinations of some known functions. Once these relationships (the coefficients of the linear combinations) are calculated according to the tensor equation set 313, we can easily find the true temperatures of the spans.

### VIII Alternate Hardware, Software, and Network Implementations

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both software and hardware elements. In some implementations, the technology is implemented in software, which includes, but is not limited to, firmware, resident software, microcode, etc. Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies, and other aspects are not mandatory or significant, and the mechanisms that implement the present techniques and technologies or its features may have different names, divisions, and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative but not limiting.

### BIBLIOGRAPHY

The following references are hereby incorporated by reference.
Ashrafi, A., Rasouli, M., & Sabzehgar, R. (2021). U.S. Pat. No. 11,063,472 B1.
Bendjabeur, A., Kouadri, A., & Mekhilef, S. (2020). Novel technique for transmission line parameters estimation using synchronised sampled data. IET Generation, Transmission & Distribution, 14 (3), 506-515.
Borda, C., Olarte, A., & Diaz, H. (2009). PMU-based line and transformer parameter estimation. Borda, Carlos, Andres Olarte, and Hernando Diaz. “PMU-based line and transformer parameter estimation.” 2009 IEEE/PES Power Systems Conference and Exposition. IEEE.
Du, Y., & Liao, Y. (2012). On-line estimation of transmission line parameters, temperature and sag using PMU measurements. Electric Power Systems Research, 93, 39-45.
Glover, J. D., Sarma, M. S., & Overbye, T. (2012). Power system analysis & design, SI version. Cengage Learning.
Gutman, R., Marchenko, P., & Dunlop, R. (1979). Analytical development of loadability characteristics for ehv and uhv transmission lines. IEEE Transactions on Power Apparatus and Systems, 2, 606-617.
IEEE-738 Standard for Calculating the Current-Temperature Relationship of Bare Overhead Conductors. (2012). IEEE.
Kersting, W. H., & Kerestes, R. (2022). Distribution System Modeling and Analysis with MATLAB® and WindMil®. (5th, Ed.) CRC Press.
Khalaj-Amirhosseini, M. (2008). A closed form analytic solution for coupled nonuniform transmission lines. Progress In Electromagnetics Research C, 1, 95-103.
Khalili, R., & Abur, A. (2021). Transmission line parameter error identification and estimation in three-phase networks. IEEE Transactions on Power Systems, 37 (3), 2271-2282.
Milojević, V., Čalija, S., Rietveld, G., Ačanski, M. V., & Colangelo, D. (2018). Utilization of pmu measurements for three-phase line parameter estimation in power systems. IEEE Transactions on Instrumentation and Measurement, 67 (10), 2453-2462.
Milojević, V., Čalija, S., Rietveld, G., Ačanski, M. V., & Colangelo, D. (2018). Utilization of PMU measurements for three-phase line parameter estimation in power systems. IEEE Transactions on Instrumentation and Measurement, 67 (10), 2453-2462.
P. Lancaster and M. Tismenetsky. (1985). The theory of matrices: with applications. Elsevier.
Paul, C. R. (2007). Analysis of multiconductor transmission lines. John Wiley & Sons.
Paul, C. R. (2007). Analysis of multiconductor transmission lines. John Wiley & Sons.
Pegoraro, P. A., Sitzia, C., Solinas, A. V., & & Sulis, S. (2022). Pmu-based estimation of systematic measurement errors, line parameters, and tap changer ratios in three-phase power systems. IEEE Transactions on Instrumentation and Measurement, 71.
Pegoraro, P. A., Sitzia, C., Solinas, A. V., & & Sulis, S. (2022). PMU-based estimation of systematic measurement errors, line parameters, and tap changer ratios in three-phase power systems. IEEE Transactions on Instrumentation and Measurement, 71.
Pegoraro, P. A., Sitzia, C., Solinas, A. V., & Sulis, S. (2022). Estimation of line parameters, tap changer ratios, and systematic measurement errors based on synchronized measurements and a general model of tap-changing transformers. IEEE Open Journal of Instrumentation and Measurement, 1.
Singh, R. S., Cobben, S., & & Ćuk, V. (2020). PMU-based cable temperature monitoring and thermal assessment for dynamic line rating. IEEE Transactions on Power Delivery, 36 (3), 1859-1868.
Singh, R. S., Cobben, S., & Ćuk, V. (2020). Pmu-based cable temperature monitoring and thermal assessment for dynamic line rating. IEEE Transactions on Power Delivery, 36 (3), 1859-1868.
Sitzia, C., Muscas, C., Pegoraro, P. A., Solinas, A. V., & Sulis, S. (2022). Enhanced pmu-based line parameters estimation and compensation of systematic measurement errors in power grids considering multiple operating conditions. IEEE Transactions on Instrumentation and Measurement, 71, 1-12.
Vicol, B. (2014). On-line overhead transmission line and transformer parameters identification based on PMU measurements. 2014 international conference and exposition on electrical and power engineering (EPE). IEEE.
Wang, C., Centeno, V. A., Jones, K. D., & Yang, D. (2019). Transmission lines positive sequence parameters estimation and instrument transformers calibration based on pmu measurement error model. IEEE Access, 7, 145104-145117.
Wang, C., Centeno, V. A., Jones, K. D., & Yang, D. (2019). Transmission Lines Positive Sequence Parameters Estimation and Instrument Transformers Calibration Based on PMU Measurement Error Model. IEEE Access, 7, 145104-145117.
Wehenkel, A., Mukhopadhyay, A., Le Boudec, J. Y., & Paolone, M. (2020). Parameter estimation of three-phase untransposed short transmission lines from synchrophasor measurements. IEEE Transactions on Instrumentation and Measurement, 69 (9), 6143-6154.
Zhao, X., Zhou, H., Shi, D., Zhao, H., Jing, C., & Jones, C. (2015). On-line pmu-based transmission line parameter identification. CSEE Journal of Power and Energy Systems, 1 (2), 68-74.
Zhou, H., Zhao, X., Shi, D., Zhao, H., & Jing, G. (2015). Calculating sequence impedances of transmission line using PMU measurements. 2015 IEEE Power & Energy Society General Meeting. IEEE.
Zupanovic, P., Juretic, D., & Botric, S. (2004). Kirchhoff's loop law and the maximum entropy production principle. Physical Review E, 70 (5), 056108.

What is claimed is:

1. A system for monitoring and managing an electric power grid, comprising:
a dynamic line rating engine configured to generate a line rating based on received time series phasor data of currents and voltages measured by synchro-phasor measurement units (PMUs) at two ends of an electric power transmission line, weather data, solar radiation data, and utility conductor parameters of the transmission line;
the dynamic line rating engine generating preliminary estimates of temperatures of spans utilizing a heat balance equation that takes into account for a magnitude of the currents determined from the phasor data, the weather data, the solar radiation data, and the utility conductor parameters; and
the dynamic line rating engine correcting the preliminary estimates of temperatures of spans, over a selected number of sample periods, by utilizing average line parameters calculated from the phasor data, as a source of information to determine coefficients of a non-linear correction equation.

2. The system of claim 1, wherein the average line parameters include average per unit line resistances.

3. The system of claim 1, wherein the dynamic line rating engine performs transmission line matrix calculations for the impedance \tilde{Z} and admittance \tilde{Y}, based on the phasor data, with the matrix calculations used to determine a line length and properties per unit length for a known transmission line geometry.

4. The system of claim 2, wherein the non-linear correction equation is a linear matrix of Taylor series expansions.

5. The system of claim 1, wherein the dynamic line rating engine determines a true temperature for each span and an ampacity for the spans taking into account the true temperature of each span.

6. The system of claim 1, wherein the preliminary estimates of temperatures of spans utilizing a heat balance equation is compliant with the Institute of Electrical and Electronics Engineers (IEEE) 738 standard.

7. A system for monitoring and managing an electric power grid, comprising:
a dynamic line rating engine configured to receive time series phasor data measured at two ends of an electric power transmission line measured by synchro-phasor measurement units (PMUs), implement a heat balance equation to generate preliminary span temperatures, correct the preliminary spans temperatures to true span temperatures, and determine a line rating.

8. The system of claim 7, wherein the dynamic line rating engine monitors at least one of ampacity, loadability, resistance inductance, shunt inductance, shunt inductance capacitance, and surge impedance loading.

9. The system of claim 7, wherein the dynamic line rating engine performs transmission line matrix calculations for the impedance \tilde{Z} and admittance \tilde{Y}, based on the phasor data, with the matrix calculations used to determine a line length and properties per unit length for a known transmission line geometry.

10. The system of claim 7, wherein the dynamic line rating engine performs transmission line matrix calculations for the impedance \tilde{Z} and admittance \tilde{Y}, based on the phasor data, with the matrix calculations constrained by introducing attributes of the conductance, resistance, inductance, and capacitive matrices.

11. The system of claim 10, wherein the dynamic line rating engine limits a search area of \tilde{Z} and \tilde{Y} matrix transmission line calculations based on constraints associated with physical characteristics of the transmission line, with the constraints including the sign of the entries of \tilde{Z} and \tilde{Y} matrices as well as the properties of the matrices including that the \tilde{Y} matrix is hyper-dominant, and the \tilde{Z} matrix has all positive entries, and it is diagonally dominant.

12. The system of claim 9, wherein the dynamic line rating engine limits a search area of \tilde{Z} and \tilde{Y} matrix transmission line calculations based on physical characteristics of the transmission line.

13. The system of claim 9, wherein the dynamic line rating engine is further configured to receive weather data for the location of the electric power transmission line; and calculate a temperature of the transmission line for each span.

14. The system of claim 7, further comprising a line health engine to identify changes to transmission line parameters indicative of line health conditions including at least one member from the group consisting of galloping. ice buildup, vegetation encroachment, imperfect splicing, and conductor corrosion.

15. A system for monitoring and managing an electric power grid, comprising:
a dynamic line rating engine configured to receive time series phasor data measured at two ends of an electric power transmission line and in response determine transmission line parameters in real-time;
the dynamic line rating engine using a deterministic algorithm organized to avoid ill-poised matric equations including introducing constraints based on transmission line properties to reduce a search space.

16. The system of claim 1, wherein dynamic line rating engine performs transmission line matrix calculations, based on the phasor data, with the matrix calculations converted into a reduced search space with computations organized to be insensitive to noise and measurement tolerances reduce the variability of the solution.

17. The system of claim 10, wherein the dynamic line rating engine limits a search area of \tilde{Z} and \tilde{Y} matrix transmission line calculations based on physical characteristics of the transmission line, the constraints including the sign of the entries of \tilde{Z} and \tilde{Y} matrices as well as the properties of the matrices including that the \tilde{Y} matrix is hyper-dominant, and the \tilde{Z} matrix has all positive entries, and it is diagonally dominant.

18. The system of claim 10, wherein the dynamic line rating engine performs a portion of the \tilde{Z} and \tilde{Y} matrix transmission line calculations by converting the portion of the calculations into a quadratic program with linear constraints to reduce noise sensitivity.

19. A method of generating a dynamic line rating of an electric power transmission line, comprising:
monitoring phasor data at two ends of the transmission line;
receiving weather data;
utilizing properties of the transmission line to avoid ill-poised matric calculation and reduce a search space for an optimization problem associated with expressing matrix equations for conductance and admittance \tilde{Z} and \tilde{Y};
determining line rating parameters using the phasor data, the transmission line parameters, and weather data in the reduced search space.

20. The method of claim 19, wherein the dynamic line rating includes at least one of ampacity, loadability, resistance inductance, shunt inductance, shunt inductance capacitance, and surge impedance loading.

21. The method of claim 19, wherein the transmission line matrix calculations are used to generate line length and properties per unit length for a known transmission line geometry.

22. The method of claim 19 wherein the transmission line matrix calculations for impedance \tilde{Z} and admittance \tilde{Y} are constrained by introducing attributes of the conductance, resistance, inductance, and capacitive matrices.

23. The method of claim 19, wherein the dynamic line rating engine limits a search area of \tilde{Z} and \tilde{Y} matrix transmission line calculations based on constraints associated with physical characteristics of the transmission line, with the constraints including the sign of the entries of \tilde{Z} and \tilde{Y} matrices as well as the properties of the matrices including that the \tilde{Y} matrix is hyper-dominant, and the \tilde{Z} matrix has all positive entries, and it is diagonally dominant.

24. The method of claim 19, further comprising generating line health information associated with at least one of galloping, icing, vegetative encroachment, imperfect splicing, and conductive corrosion.

25. The method of claim 19, further comprising:
generating preliminary estimates of temperatures of spans utilizing a heat balance equation that takes into account for a magnitude of the currents determined from the phasor data, the weather data, solar radiation data, and the utility conductor parameters; and
correcting the preliminary estimates of temperatures of spans, over a selected number of sample periods, by utilizing average line parameters calculated from the phasor data, as a source of information to determine coefficients of a non-linear correction equation.
